(19) United States
(12) Patent Application Publication
(10) Pub. No.: US 2014/0132726 A1
(43) Pub. Date: May 15, 2014

(54) IMAGE DISPLAY APPARATUS AND METHOD FOR OPERATING THE SAME

(71) Applicant: LG ELECTRONICS INC., Seoul (KR)

(72) Inventors: Youngkyung JUNG, Seoul (KR); Jayoen KIM, Seoul (KR); Kyoungha LEE, Seoul (KR)

(73) Assignee: LG ELECTRONICS INC., Seoul (KR)

(21) Appl. No.: 14/046,706

(22) Filed: Oct. 4, 2013

(30) Foreign Application Priority Data
Nov. 13, 2012 (KR) 10-2012-0128272

(51) Int. Cl. H04N 13/04; H04N 5/445

(52) U.S. Cl. CPC H04N 13/0468; H04N 13/0404; H04N 5/44582
USPC 348/46; 348/59

(57) ABSTRACT

An image display apparatus and a method for operating the same are disclosed. The image display apparatus includes a camera configured to capture image; a display configured to display a three-dimensional content screen, and a controller configured to change at least one of a depth of a predetermined object in the 3D content screen or an on screen display (OSD) if the OSD is included in the 3D content screen, wherein the display displays a 3D content screen including the object or OSD having the changed depth. Accordingly, it is possible to increase user convenience.

### CROSS-REFERENCE TO RELATED APPLICATION

This application claims the priority benefit of Korean Patent Application No. 10-2012-0128272, filed on Nov. 13, 2012, in the Korean Intellectual Property Office, the disclosure of which is incorporated herein by reference.

### BACKGROUND OF THE INVENTION

1. Field of the Invention

The present invention relates to an image display apparatus and a method for operating the same, and more particularly, to an image display apparatus and a method for operating the same, which are capable of increasing user convenience.

2. Description of the Related Art

An image display apparatus functions to display images to a user. A user can view a broadcast program using an image display apparatus. The image display apparatus can display a broadcast program selected by the user on a display from among broadcast programs transmitted from broadcast stations. The recent trend in broadcasting is a worldwide transition from analog broadcasting to digital broadcasting.

Digital broadcasting transmits digital audio and video signals. Digital broadcasting offers many advantages over analog broadcasting, such as robustness against noise, less data loss, ease of error correction, and the ability to provide clear, high-definition images. Digital broadcasting also allows interactive viewer services, compared to analog broadcasting.

### SUMMARY OF THE INVENTION

Therefore, the present invention has been made in view of the above problems, and it is an object of the present invention to provide an image display apparatus and a method for operating the same, which are capable of increasing user convenience.

Another object of the present invention is to provide an image display apparatus and a method for operating the same that are capable of improving readability of an on screen display (OSD) upon display of 3D content.

In accordance with an aspect of the present invention, the above and other objects can be accomplished by the provision of an image display apparatus including a camera configured to capture image; a display configured to display a three-dimensional content screen, and a controller configured to change at least one of a depth of a predetermined object in the 3D content screen or an on screen display (OSD) if the OSD is included in the 3D content screen, wherein the display displays a 3D content screen including the object or OSD having the changed depth.

In accordance with another aspect of the present invention, In accordance with another aspect of the present invention, there is provided a method for operating an image display apparatus including displaying a three-dimensional (3D) content screen, changing at least one of a depth of a predetermined object in the 3D content screen or an on screen display (OSD) if the OSD is included in the 3D content screen, and displaying a 3D content screen including the object or OSD with the changed depth.

In accordance with another aspect of the present invention, there is provided a method for operating an image display apparatus including displaying a 3D content screen, changing at least one of a depth of a predetermined object in the 3D content screen or an on screen display (OSD) if the OSD is included in the 3D content screen and the depth of the predetermined object in the 3D content screen is set to be different from the depth of the OSD, changing at least one of a position or shape of the OSD if the OSD is included in the 3D content screen and the depth of the predetermined object in the 3D content screen is set to be equal to the depth of the OSD, and displaying a 3D content screen including the object or OSD with the changed depth or a 3D content screen including the OSD, the position or shape of which is changed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the appearance of an image display apparatus according to an embodiment of the present invention;

FIG. 2 is a view showing a lens unit and a display of the image display apparatus of FIG. 1;

FIG. 3 is a block diagram showing the internal configuration of an image display apparatus according to an embodiment of the present invention;

FIG. 4 is a block diagram showing the internal configuration of a controller of FIG. 3;

FIG. 5 is a diagram showing a method of controlling a remote controller of FIG. 3;

FIG. 6 is a block diagram showing the internal configuration of the remote controller of FIG. 3;

FIG. 7 is a diagram illustrating images formed by a left-eye image and a right-eye image;

FIG. 8 is a diagram illustrating the depth of a 3D image according to a disparity between a left-eye image and a right-eye image;

FIG. 9 is a view referred to for describing the principle of a glassless stereoscopic image display apparatus;

FIGS. 10 to 14 are views referred to for describing the principle of an image display apparatus including multi-view images;

FIGS. 15a to 15b are views referred to for describing a user gesture recognition principle;

FIG. 16 is a view referred to for describing operation corresponding to a user gesture;

FIG. 17 is a flowchart illustrating a method for operating an image display apparatus according to an embodiment of the present invention; and

FIGS. 18a to 28 are views referred to for describing various examples of the method for operating the image display apparatus of FIG. 17.

### DETAILED DESCRIPTION OF THE PREFERRED EMBODIMENTS

Exemplary embodiments of the present invention will be described with reference to the attached drawings.

The terms “module” and “unit” used in description of components are used herein to help the understanding of the components and thus should not be misconstrued as having specific meanings or roles. Accordingly, the terms “module” and “unit” may be used interchangeably.

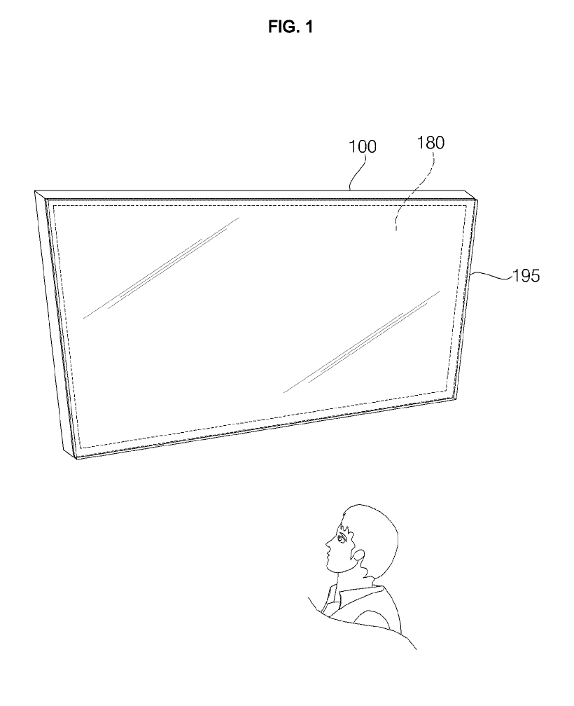

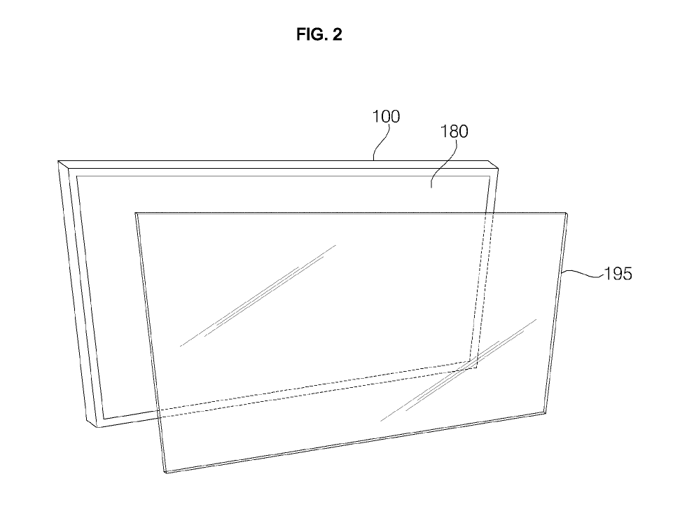

FIG. 1 is a diagram showing the appearance of an image display apparatus according to an embodiment of the present invention, and FIG. 2 is a view showing a lens unit and a display of the image display apparatus of FIG. 1.

Referring to the figures, the image display apparatus according to the embodiment of the present invention is able to display a stereoscopic image, that is, a three-dimensional (3D) image. In the embodiment of the present invention, a glassless 3D image display apparatus is used.

The image display apparatus 100 includes a display 180 and a lens unit 195.

The display 180 may display an input image and, more particularly, may display multi-view images according to the embodiment of the present invention. More specifically, subpixels configuring the multi-view images are arranged in a predetermined pattern.

The lens unit 195 may be spaced apart from the display 180 at a side close to a user. In FIG. 2, the display 180 and the lens unit 195 are separated.

The lens unit 195 may be configured to change a travel direction of light according to supplied power. For example, if a plurality of viewers views a 2D image, first power may be supplied to the lens unit 195 to emit light in the same direction as light emitted from the display 180. Thus, the image display apparatus 100 may provide a 2D image to the plurality of viewers.

In contrast, if the plurality of viewers views a 3D image, second power may be supplied to the lens unit 195 such that light emitted from the display 180 is scattered. Thus, the image display apparatus 100 may provide a 3D image to the plurality of viewers.

The lens unit 195 may use a lenticular method using a lenticular lens, a parallax method using a slit array, a method of using a micro lens array, etc. In the embodiment of the present invention, the lenticular method will be focused upon.

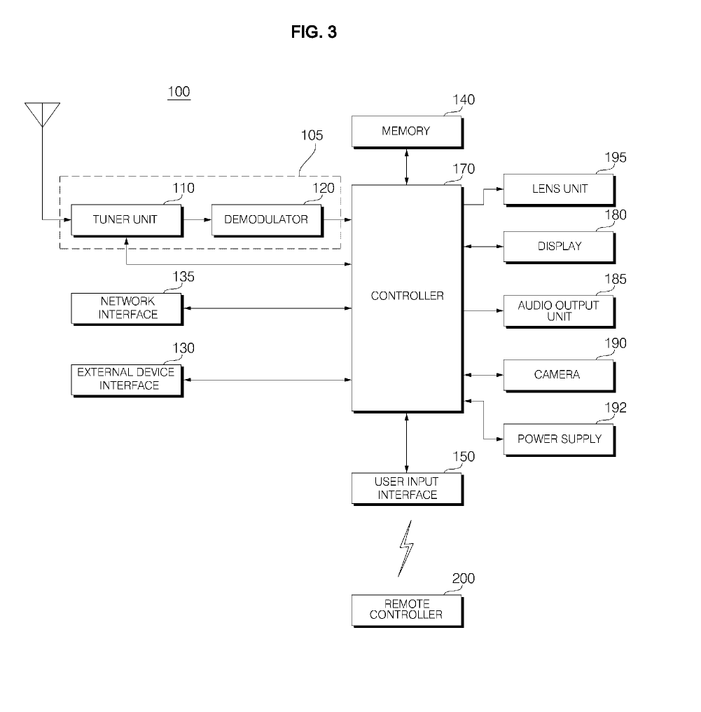

FIG. 3 is a block diagram showing the internal configuration of an image display apparatus according to an embodiment of the present invention.

Referring to FIG. 3, the image display apparatus 100 according to the embodiment of the present invention includes a broadcast reception unit 105, an external device interface 130, a memory 140, a user input interface 150, a camera unit 190, a sensor unit (not shown), a controller 170, a display 180, an audio output unit 185, a power supply 192 and a lens unit 195.

The broadcast reception unit 105 may include a tuner unit 110, a demodulator 120 and a network interface 130. As needed, the broadcasting reception unit 105 may be configured so as to include only the tuner unit 110 and the demodulator 120 or only the network interface 130.

The tuner unit 110 tunes to a Radio Frequency (RF) broadcast signal corresponding to a channel selected by a user from among RF broadcast signals received through an antenna or RF broadcast signals corresponding to all channels previously stored in the image display apparatus. The tuned RF broadcast is converted into an Intermediate Frequency (IF) signal or a baseband Audio/Video (AV) signal.

For example, the tuned RF broadcast signal is converted into a digital IF signal DIF if it is a digital broadcast signal and is converted into an analog baseband AV signal (Composite Video Banking Sync/Sound Intermediate Frequency (CUBS/SIF)) if it is an analog broadcast signal. That is, the tuner unit 110 may be capable of processing not only digital broadcast signals but also analog broadcast signals. The analog baseband A/V signal CVBS/SIF may be directly input to the controller 170.

The tuner unit 110 may be capable of receiving RF broadcast signals from an Advanced Television Systems Committee (ATSC) single-carrier system or from a Digital Video Broadcasting (DVB) multi-carrier system.

The tuner unit 110 may sequentially select a number of RF broadcast signals corresponding to all broadcast channels previously stored in the image display apparatus by a channel storage function from among a plurality of RF signals received through the antenna and may convert the selected RF broadcast signals into IF signals or baseband A/V signals.

The tuner unit 110 may include a plurality of tuners for receiving broadcast signals corresponding to a plurality of channels or include a single tuner for simultaneously receiving broadcast signals corresponding to the plurality of channels.

The demodulator 120 receives the digital IF signal DIF from the tuner unit 110 and demodulates the digital IF signal DIF.

The demodulator 120 may perform demodulation and channel decoding, thereby obtaining a stream signal TS. The stream signal may be a signal in which a video signal, an audio signal and a data signal are multiplexed.

The stream signal output from the demodulator 120 may be input to the controller 170 and thus subjected to demultiplexing and A/V signal processing. The processed video and audio signals are output to the display 180 and the audio output unit 185, respectively.

The external device interface 130 may transmit or receive data to or from a connected external device (not shown). The external device interface 130 may include an A/V Input/Output (I/O) unit (not shown) or a radio transceiver (not shown).

The external device interface 130 may be connected to an external device such as a Digital Versatile Disc (DVD) player, a Blu-ray player, a game console, a camera, a camcorder, or a computer (e.g., a laptop computer), wirelessly or by wire so as to perform an input/output operation with respect to the external device.

The A/V I/O unit may receive video and audio signals from an external device. The radio transceiver may perform short-range wireless communication with another electronic apparatus.

The network interface 135 serves as an interface between the image display apparatus 100 and a wired/wireless network such as the Internet. For example, the network interface 135 may receive content or data provided by an Internet or content provider or a network operator over a network.

The memory 140 may store various programs necessary for the controller 170 to process and control signals, and may also store processed video, audio and data signals.

In addition, the memory 140 may temporarily store a video, audio and/or data signal received from the external device interface 130. The memory 140 may store information about a predetermined broadcast channel by the channel storage function of a channel map.

While the memory 140 is shown in FIG. 3 as being configured separately from the controller 170, to which the present invention is not limited, the memory 140 may be incorporated into the controller 170.

The user input interface 150 transmits a signal input by the user to the controller 170 or transmits a signal received from the controller 170 to the user.

For example, the user input interface 150 may transmit/receive various user input signals such as a power-on/off signal, a channel selection signal, and a screen setting signal from a remote controller 200, may provide the controller 170 with user input signals received from local keys (not shown), such as inputs of a power key, a channel key, and a volume key, and setting values, provide the controller 170 with a user input signal received from a sensor unit (not shown) for sensing a user gesture, or transmit a signal received from the controller 170 to a sensor unit (not shown).

The controller 170 may demultiplex the stream signal received from the tuner unit 110, the demodulator 120, or the external device interface 130 into a number of signals, process the demultiplexed signals into audio and video data, and output the audio and video data.

The video signal processed by the controller 170 may be displayed as an image on the display 180. The video signal processed by the controller 170 may also be transmitted to an external output device through the external device interface 130.

The audio signal processed by the controller 170 may be output to the audio output unit 185. In addition, the audio signal processed by the controller 170 may be transmitted to the external output device through the external device interface 130.

While not shown in FIG. 3, the controller 170 may include a DEMUX, a video processor, etc., which will be described in detail later with reference to FIG. 4.

The controller 170 may control the overall operation of the image display apparatus 100. For example, the controller 170 controls the tuner unit 110 to tune to an RF signal corresponding to a channel selected by the user or a previously stored channel.

The controller 170 may control the image display apparatus 100 according to a user command input through the user input interface 150 or an internal program.

The controller 170 may control the display 180 to display images. The image displayed on the display 180 may be a Two-Dimensional (2D) or Three-Dimensional (3D) still or moving image.

The controller 170 may generate and display a predetermined object of an image displayed on the display 180 as a 3D object. For example, the object may be at least one of a screen of an accessed web site (newspaper, magazine, etc.), an electronic program guide (EPG), various menus, a widget, an icon, a still image, a moving image, text, etc.

Such a 3D object may be processed to have a depth different from that of an image displayed on the display 180. Preferably, the 3D object may be processed so as to appear to protrude from the image displayed on the display 180.

The controller 170 may recognize the position of the user based on an image captured by the camera unit 190. For example, a distance (z-axis coordinate) between the user and the image display apparatus 100 may be detected. An x-axis coordinate and a y-axis coordinate in the display 180 corresponding to the position of the user may be detected.

The controller 170 may recognize a user gesture based on the user image captured by the camera unit 190 and, more particularly, determine whether a gesture is activated using a distance between a hand and eyes of the user. Alternatively, the controller 170 may recognize other gestures according to various hand motions and arm motions.

The controller 170 may control operation of the lens unit 195. For example, the controller 170 may control first power to be supplied to the lens unit 195 upon 2D image display and second power to be supplied to the lens unit 195 upon 3D image display. Thus, light may be emitted in the same direction as light emitted from the display 180 through the lens unit 195 upon 2D image display and light emitted from the display 180 may be scattered via the lens unit 195 upon 3D image display.

Although not shown, the image display apparatus may further include a channel browsing processor (not shown) for generating thumbnail images corresponding to channel signals or external input signals. The channel browsing processor may receive stream signals TS received from the demodulator 120 or stream signals received from the external device interface 130, extract images from the received stream signal, and generate thumbnail images. The thumbnail images may be decoded and output to the controller 170, along with the decoded images. The controller 170 may display a thumbnail list including a plurality of received thumbnail images on the display 180 using the received thumbnail images.

The thumbnail list may be displayed using a simple viewing method of displaying the thumbnail list in a part of an area in a state of displaying a predetermined image or may be displayed in a full viewing method of displaying the thumbnail list in a full area. The thumbnail images in the thumbnail list may be sequentially updated.

The display 180 converts the video signal, the data signal, the OSD signal and the control signal processed by the controller 170 or the video signal, the data signal and the control signal received by the external device interface 130 and generates a drive signal.

The display 180 may be a Plasma Display Panel (PDP), a Liquid Crystal Display (LCD), an Organic Light-Emitting Diode (OLED) display or a flexible display. In particular, the display 180 may be a 3D display.

As described above, the display 180 according to the embodiment of the present invention is a glassless 3D image display that does not require glasses. The display 180 includes the lenticular lens unit 195.

The power supply 192 supplies power to the image display apparatus 100. Thus, the modules or units of the image display apparatus 100 may operate.

The display 180 may be configured to include a 2D image region and a 3D image region. In this case, the power supply 192 may supply different first power and second power to the lens unit 195. First power and second power may be supplied under control of the controller 170.

The lens unit 195 changes a travel direction of light according to supplied power.

First power may be supplied to a first region of the lens unit corresponding to a 2D image region of the display 180 such that light may be emitted in the same direction as light emitted from the 2D image region of the display 180. Thus, the user may perceive the displayed image as a 2D image.

As another example, second power may be supplied to a second region of the lens unit corresponding to a 3D image region of the display 180 such that light emitted from the 3D image region of the display 180 is scattered. Thus, the user may perceive the displayed image as a 3D image without wearing glasses.

The lens unit 195 may be spaced from the display 180 at a user side. In particular, the lens unit 195 may be provided in parallel to the display 180, may be provided to be inclined with respect to the display 180 at a predetermined angle or may be concave or convex with respect to the display 180. The lens unit 195 may be provided in the form of a sheet. The lens unit 195 according to the embodiment of the present invention may be referred to as a lens sheet.

If the display 180 is a touchscreen, the display 180 may function as not only an output device but also as an input device.

The audio output unit 185 receives the audio signal processed by the controller 170 and outputs the received audio signal as sound.

The camera unit 190 captures images of a user. The camera unit (not shown) may be implemented by one camera, but the present invention is not limited thereto. That is, the camera unit may be implemented by a plurality of cameras. The camera unit 190 may be embedded in the image display apparatus 100 at the upper side of the display 180 or may be separately provided. Image information captured by the camera unit 190 may be input to the controller 170.

The controller 170 may sense a user gesture from an image captured by the camera unit 190, a signal sensed by the sensor unit (not shown), or a combination of the captured image and the sensed signal.

The remote controller 200 transmits user input to the user input interface 150. For transmission of user input, the remote controller 200 may use various communication techniques such as Bluetooth, RF communication, IR communication, Ultra Wideband (UWB), and ZigBee. In addition, the remote controller 200 may receive a video signal, an audio signal or a data signal from the user input interface 150 and output the received signals visually or audibly based on the received video, audio or data signal.

The image display apparatus 100 may be a fixed or mobile digital broadcast receiver.

The image display apparatus described in the present specification may include a TV receiver, a monitor, a mobile phone, a smart phone, a notebook computer, a digital broadcast terminal, a Personal Digital Assistant (PDA), a Portable Multimedia Player (PMP), etc.

The block diagram of the image display apparatus 100 illustrated in FIG. 3 is only exemplary. Depending upon the specifications of the image display apparatus 100, the components of the image display apparatus 100 may be combined or omitted or new components may be added. That is, two or more components are incorporated into one component or one component may be configured as separate components, as needed. In addition, the function of each block is described for the purpose of describing the embodiment of the present invention and thus specific operations or devices should not be construed as limiting the scope and spirit of the present invention.

Unlike FIG. 3, the image display apparatus 100 may not include the tuner unit 110 and the demodulator 120 shown in FIG. 3 and may receive image content through the network interface 135 or the external device interface 130 and reproduce the image content.

The image display apparatus 100 is an example of an image signal processing apparatus that processes an image stored in the apparatus or an input image. Other examples of the image signal processing apparatus include a set-top box without the display 180 and the audio output unit 185, a DVD player, a Blu-ray player, a game console, and a computer.

FIG. 4 is a block diagram showing the internal configuration of the controller of FIG. 3.

Referring to FIG. 4, the controller 170 according to the embodiment of the present invention may include a DEMUX 310, a video processor 320, a processor 330, an OSD generator 340, a mixer 345, a Frame Rate Converter (FRC) 350, and a formatter 360. The controller 170 may further include an audio processor (not shown) and a data processor (not shown).

The DEMUX 310 demultiplexes an input stream. For example, the DEMUX 310 may demultiplex an MPEG-2 TS into a video signal, an audio signal, and a data signal. The stream signal input to the DEMUX 310 may be received from the tuner unit 110, the demodulator 120 or the external device interface 130.

The video processor 320 may process the demultiplexed video signal. For video signal processing, the video processor 320 may include a video decoder 325 and a scaler 335.

The video decoder 325 decodes the demultiplexed video signal and the scaler 335 scales the resolution of the decoded video signal so that the video signal can be displayed on the display 180.

The video decoder 325 may be provided with decoders that operate based on various standards.

The video signal decoded by the video processor 320 may include a 2D video signal, a mixture of a 2D video signal and a 3D video signal, or a 3D video signal.

For example, if an external video signal received from the external device (not shown) or a broadcast video signal received from the tuner unit 110 includes a 2D video signal, a mixture of a 2D video signal and a 3D video signal, or a 3D video signal. Thus, the controller 170 and, more particularly, the video processor 320 may perform signal processing and output a 2D video signal, a mixture of a 2D video signal and a 3D video signal, or a 3D video signal.

The decoded video signal from the video processor 320 may have any of various available formats. For example, the decoded video signal may be a 3D video signal composed of a color image and a depth image or a 3D video signal composed of multi-view image signals. The multi-view image signals may include, for example, a left-eye image signal and a right-eye image signal.

Formats of the 3D video signal may include a side-by-side format in which the left-eye image signal L and the right-eye image signal R are arranged in a horizontal direction, a top/down format in which the left-eye image signal and the right-eye image signal are arranged in a vertical direction, a frame sequential format in which the left-eye image signal and the right-eye image signal are time-divisionally arranged, an interlaced format in which the left-eye image signal and the right-eye image signal are mixed in line units, and a checker box format in which the left-eye image signal and the right-eye image signal are mixed in box units.

The processor 330 may control overall operation of the image display apparatus 100 or the controller 170. For example, the processor 330 may control the tuner unit 110 to tune to an RF broadcast corresponding to an RF signal corresponding to a channel selected by the user or a previously stored channel.

The processor 330 may control the image display apparatus 100 by a user command input through the user input interface 150 or an internal program.

The processor 330 may control data transmission of the network interface 135 or the external device interface 130.

The processor 330 may control the operation of the DEMUX 310, the video processor 320 and the OSD generator 340 of the controller 170.

The OSD generator 340 generates an OSD signal autonomously or according to user input. For example, the OSD generator 340 may generate signals by which a variety of information is displayed as graphics or text on the display 180, according to user input signals. The OSD signal may include a variety of data such as a User Interface (UI), a variety of menus, widgets, icons, etc. In addition, the OSD signal may include a 2D object and/or a 3D object.

The OSD generator 340 may generate a pointer which can be displayed on the display according to a pointing signal received from the remote controller 200. In particular, such a pointer may be generated by a pointing signal processor and the OSD generator 340 may include such a pointing signal processor (not shown). Alternatively, the pointing signal processor (not shown) may be provided separately from the OSD generator 340.

The mixer 345 may mix the decoded video signal processed by the video processor 320 with the OSD signal generated by the OSD generator 340. Each of the OSD signal and the decoded video signal may include at least one of a 2D signal and a 3D signal. The mixed video signal is provided to the FRC 350.

The FRC 350 may change the frame rate of an input image. The FRC 350 may maintain the frame rate of the input image without frame rate conversion.

The formatter 360 may arrange 3D images subjected to frame rate conversion.

The formatter 360 may receive the signal mixed by the mixer 345, that is, the OSD signal and the decoded video signal, and separate a 2D video signal and a 3D video signal.

In the present specification, a 3D video signal refers to a signal including a 3D object such as a Picture-In-Picture (PIP) image (still or moving), an EPG that describes broadcast programs, a menu, a widget, an icon, text, an object within an image, a person, a background, or a web page (e.g. from a newspaper, a magazine, etc.).

The formatter 360 may change the format of the 3D video signal. For example, if 3D video is received in the various formats described above, video may be changed to a multi-view image. In particular, the multi-view image may be repeated. Thus, it is possible to display glassless 3D video.

Meanwhile, the formatter 360 may convert a 2D video signal into a 3D video signal. For example, the formatter 360 may detect edges or a selectable object from the 2D video signal and generate an object according to the detected edges or the selectable object as a 3D video signal. As described above, the 3D video signal may be a multi-view image signal.

Although not shown, a 3D processor (not shown) for 3D effect signal processing may be further provided next to the formatter 360. The 3D processor (not shown) may control brightness, tint, and color of the video signal, to enhance the 3D effect.

The audio processor (not shown) of the controller 170 may process the demultiplexed audio signal. For audio processing, the audio processor (not shown) may include various decoders.

The audio processor (not shown) of the controller 170 may also adjust the bass, treble or volume of the audio signal.

The data processor (not shown) of the controller 170 may process the demultiplexed data signal. For example, if the demultiplexed data signal was encoded, the data processor may decode the data signal. The encoded data signal may be Electronic Program Guide (EPG) information including broadcasting information such as the start time and end time of broadcast programs of each channel.

Although the formatter 360 performs 3D processing after the signals from the OSD generator 340 and the video processor 320 are mixed by the mixer 345 in FIG. 4, the present invention is not limited thereto and the mixer may be located at a next stage of the formatter. That is, the formatter 360 may perform 3D processing with respect to the output of the video processor 320, the OSD generator 340 may generate the OSD signal and perform 3D processing with respect to the OSD signal, and then the mixer 345 may mix the respective 3D signals.

The block diagram of the controller 170 shown in FIG. 4 is exemplary. The components of the block diagrams may be integrated or omitted, or a new component may be added according to the specifications of the controller 170.

In particular, the FRC 350 and the formatter 360 may be included separately from the controller 170.

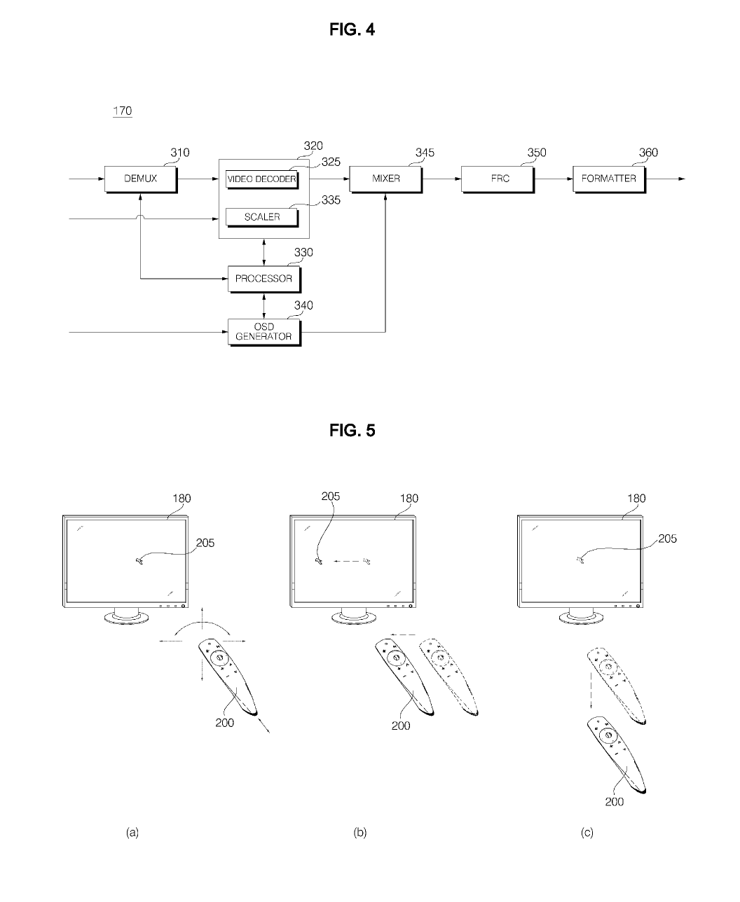

FIG. 5 is a diagram showing a method of controlling a remote controller of FIG. 3.

As shown in FIG. 5(a), a pointer 205 representing movement of the remote controller 200 is displayed on the display 180.

The user may move or rotate the remote controller 200 up and down, side to side (FIG. 5(b)), and back and forth (FIG. 5(c)). The pointer 205 displayed on the display 180 of the image display apparatus corresponds to the movement of the remote controller 200. Since the pointer 205 moves according to movement of the remote controller 200 in a 3D space as shown in the figure, the remote controller 200 may be referred to as a pointing device.

Referring to FIG. 5(b), if the user moves the remote controller 200 to the left, the pointer 205 displayed on the display 180 of the image display apparatus 200 moves to the left.

A sensor of the remote controller 200 detects movement of the remote controller 200 and transmits motion information corresponding to the result of detection to the image display apparatus. Then, the image display apparatus may calculate the coordinates of the pointer 205 from the motion information of the remote controller 200. The image display apparatus then displays the pointer 205 at the calculated coordinates.

Referring to FIG. 5(c), while pressing a predetermined button of the remote controller 200, the user moves the remote controller 200 away from the display 180. Then, a selected area corresponding to the pointer 205 may be zoomed in on and enlarged on the display 180. On the contrary, if the user moves the remote controller 200 toward the display 180, the selection area corresponding to the pointer 205 is zoomed out and thus contracted on the display 180. Alternatively, when the remote controller 200 moves away from the display 180, the selection area may be zoomed out on and when the remote controller 200 approaches the display 180, the selection area may be zoomed in on.

With the predetermined button pressed in the remote controller 200, the up, down, left and right movement of the remote controller 200 may be ignored. That is, when the remote controller 200 moves away from or approaches the display 180, only the back and forth movements of the remote controller 200 are sensed, while the up, down, left and right movements of the remote controller 200 are ignored. If the predetermined button of the remote controller 200 is not pressed, only the pointer 205 moves in accordance with the up, down, left or right movement of the remote controller 200.

The speed and direction of the pointer 205 may correspond to the speed and direction of the remote controller 200.

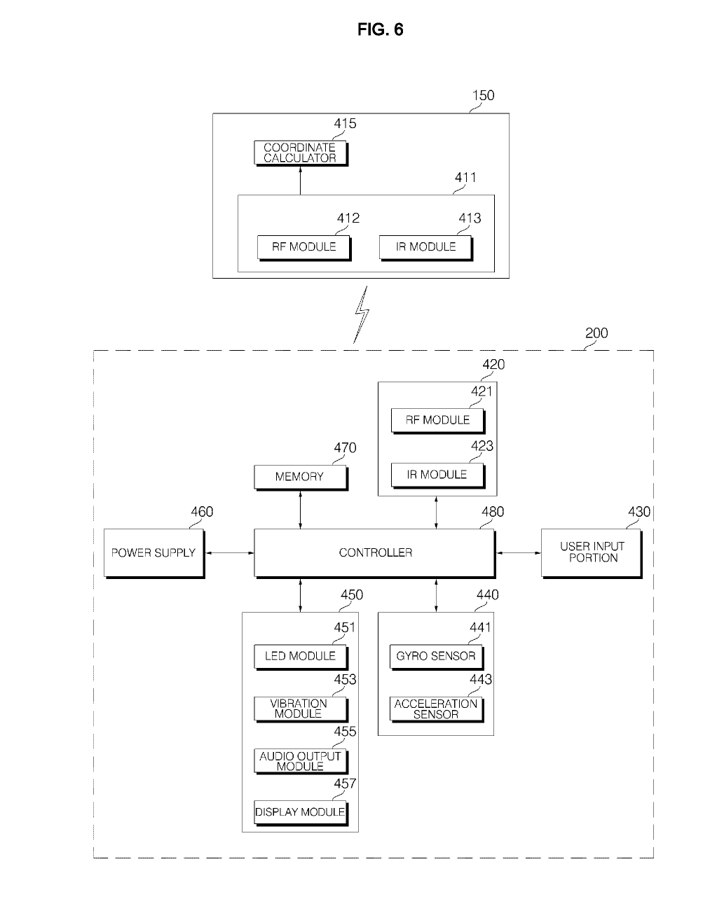

FIG. 6 is a block diagram showing the internal configuration of the remote controller of FIG. 3.

Referring to FIG. 6, the remote controller 200 may include a radio transceiver 420, a user input portion 430, a sensor portion 440, an output portion 450, a power supply 460, a memory 460, and a controller 480.

The radio transceiver 420 transmits and receives signals to and from any one of the image display apparatuses according to the embodiments of the present invention. Among the image display apparatuses according to the embodiments of the present invention, for example, one image display apparatus 100 will be described.

In accordance with the exemplary embodiment of the present invention, the remote controller 200 may include an RF module 421 for transmitting and receiving signals to and from the image display apparatus 100 according to an RF communication standard. Additionally, the remote controller 200 may include an IR module 423 for transmitting and receiving signals to and from the image display apparatus 100 according to an IR communication standard.

In the present embodiment, the remote controller 200 may transmit information about movement of the remote controller 200 to the image display apparatus 100 via the RF module 421.

The remote controller 200 may receive the signal from the image display apparatus 100 via the RF module 421. The remote controller 200 may transmit commands associated with power on/off, channel change, volume change, etc. to the image display apparatus 100 through the IR module 423.

The user input portion 430 may include a keypad, a key (button), a touch pad or a touchscreen. The user may enter a command related to the image display apparatus 100 to the remote controller 200 by manipulating the user input portion 430. If the user input portion 430 includes hard keys, the user may enter commands related to the image display apparatus 100 to the remote controller 200 by pushing the hard keys. If the user input portion 430 is provided with a touchscreen, the user may enter commands related to the image display apparatus 100 through the remote controller 200 by touching soft keys on the touchscreen. Additionally, the user input portion 430 may have a variety of input means that can be manipulated by the user, such as a scroll key, a jog key, etc., to which the present invention is not limited thereto.

The sensor portion 440 may include a gyro sensor 441 or an acceleration sensor 443. The gyro sensor 441 may sense information about movement of the remote controller 200.

For example, the gyro sensor 441 may sense information about movement of the remote controller 200 along x, y and z axes. The acceleration sensor 443 may sense information about the speed of the remote controller 200. The sensor portion 440 may further include a distance measurement sensor for sensing a distance from the display 180.

The output portion 450 may output a video or audio signal corresponding to manipulation of the user input portion 430 or a signal transmitted by the image display apparatus 100. The output portion 450 lets the user know whether the user input portion 430 has been manipulated or the image display apparatus 100 has been controlled.

For example, the output portion 450 may include a Light Emitting Diode (LED) module 451 for illuminating when the user input portion 430 has been manipulated or a signal is transmitted to or received from the image display apparatus 100 through the radio transceiver 420, a vibration module 453 for generating vibrations, an audio output module 455 for outputting audio, or a display module 457 for outputting video.

The power supply 460 supplies power to the remote controller 200. When the remote controller 200 remains stationary for a predetermined time, the power supply 460 blocks power from the remote controller 200, thereby preventing unnecessary power consumption. When a predetermined key of the remote controller 200 is manipulated, the power supply 460 may resume power supply.

The memory 470 may store a plurality of types of programs required for control or operation of the remote controller 200, or application data. When the remote controller 200 transmits and receives signals to and from the image display apparatus 100 wirelessly through the RF module 421, the remote controller 200 and the image display apparatus 100 perform signal transmission and reception in a predetermined frequency band. The controller 480 of the remote controller 200 may store information about the frequency band in which signals are wirelessly transmitted received to and from the image display apparatus 100 paired with the remote controller 200 in the memory 470 and refer to the information.

The controller 480 provides overall control to the remote controller 200. The controller 480 may transmit a signal corresponding to predetermined key manipulation of the user input portion 430 or a signal corresponding to movement of the remote controller 200 sensed by the sensor portion 440 to the image display apparatus 100 through the radio transceiver 420.

The user input interface 150 of the image display apparatus 100 may have a radio transceiver 411 for wirelessly transmitting and receiving signals to and from the remote controller 200, and a coordinate calculator 415 for calculating the coordinates of the pointer corresponding to an operation of the remote controller 200.

The user input interface 150 may transmit and receive signals wirelessly to and from the remote controller 200 through an RF module 412. The user input interface 150 may also receive a signal from the remote controller 200 through an IR module 413 based on an IR communication standard.

The coordinate calculator 415 may calculate the coordinates (x, y) of the pointer 205 to be displayed on the display 180 by correcting hand tremor or errors from a signal corresponding to an operation of the remote controller 200 received through the radio transceiver 411.

A signal transmitted from the remote controller 200 to the image display apparatus 100 through the user input interface 150 is provided to the controller 170 of the image display apparatus 100. The controller 170 may identify information about an operation of the remote controller 200 or key manipulation of the remote controller 200 from the signal received from the remote controller 200 and control the image display apparatus 100 according to the information.

In another example, the remote controller 200 may calculate the coordinates of the pointer corresponding to the operation of the remote controller and output the coordinates to the user input interface 150 of the image display apparatus 100. The user input interface 150 of the image display apparatus 100 may then transmit information about the received coordinates of the pointer to the controller 170 without correcting hand tremor or errors.

As another example, the coordinate calculator 415 may be included in the controller 170 instead of the user input interface 150.

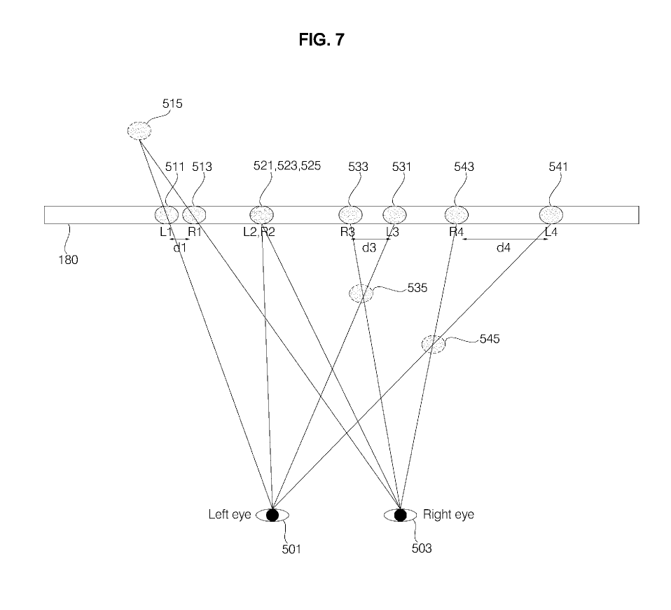

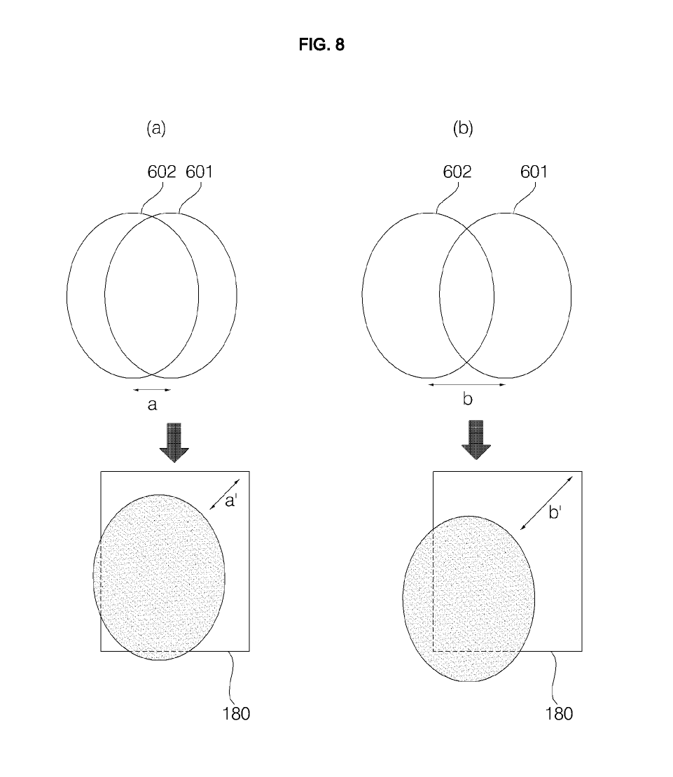

FIG. 7 is a diagram illustrating images formed by a left-eye image and a right-eye image, and FIG. 8 is a diagram illustrating the depth of a 3D image according to a disparity between a left-eye image and a right-eye image.

First, referring to FIG. 7, a plurality of images or a plurality of objects 515, 525, 535 or 545 is shown.

A first object 515 includes a first left-eye image 511 (L) based on a first left-eye image signal and a first right-eye image 513 (R) based on a first right-eye image signal, and a disparity between the first left-eye image 511 (L) and the first right-eye image 513 (R) is dl on the display 180. The user sees an image as formed at the intersection between a line connecting a left eye 501 to the first left-eye image 511 and a line connecting a right eye 503 to the first right-eye image 513. Therefore, the user perceives the first object 515 as being located behind the display 180.

Since a second object 525 includes a second left-eye image 521 (L) and a second right-eye image 523 (R), which are displayed on the display 180 to overlap, a disparity between the second left-eye image 521 and the second right-eye image 523 is 0. Thus, the user perceives the second object 525 as being on the display 180.

A third object 535 includes a third left-eye image 531 (L) and a third right-eye image 533 (R) and a fourth object 545 includes a fourth left-eye image 541 (L) with a fourth right-eye image 543 (R). A disparity between the third left-eye image 531 and the third right-eye images 533 is d3 and a disparity between the fourth left-eye image 541 and the fourth right-eye image 543 is d4.

The user perceives the third and fourth objects 535 and 545 at image-formed positions, that is, as being positioned in front of the display 180.

Because the disparity d4 between the fourth left-eye image 541 and the fourth right-eye image 543 is greater than the disparity d3 between the third left-eye image 531 and the third right-eye image 533, the fourth object 545 appears to be positioned closer to the viewer than the third object 535.

In embodiments of the present invention, the distances between the display 180 and the objects 515, 525, 535 and 545 are represented as depths. When an object is perceived as being positioned behind the display 180, the object has a negative depth value. On the other hand, when an object is perceived as being positioned in front of the display 180, the object has a positive depth value. That is, the depth value is proportional to apparent proximity to the user.

Referring to FIG. 8, if the disparity a between a left-eye image 601 and a right-eye image 602 in FIG. 8(a) is smaller than the disparity b between the left-eye image 601 and the right-eye image 602 in FIG. 8(b), the depth a′ of a 3D object created in FIG. 8(a) is smaller than the depth b′ of a 3D object created in FIG. 8(b).

In the case where a left-eye image and a right-eye image are combined into a 3D image, the positions of the images perceived by the user are changed according to the disparity between the left-eye image and the right-eye image. This means that the depth of a 3D image or 3D object formed of a left-eye image and a right-eye image in combination may be controlled by adjusting the disparity between the left-eye and right-eye images.

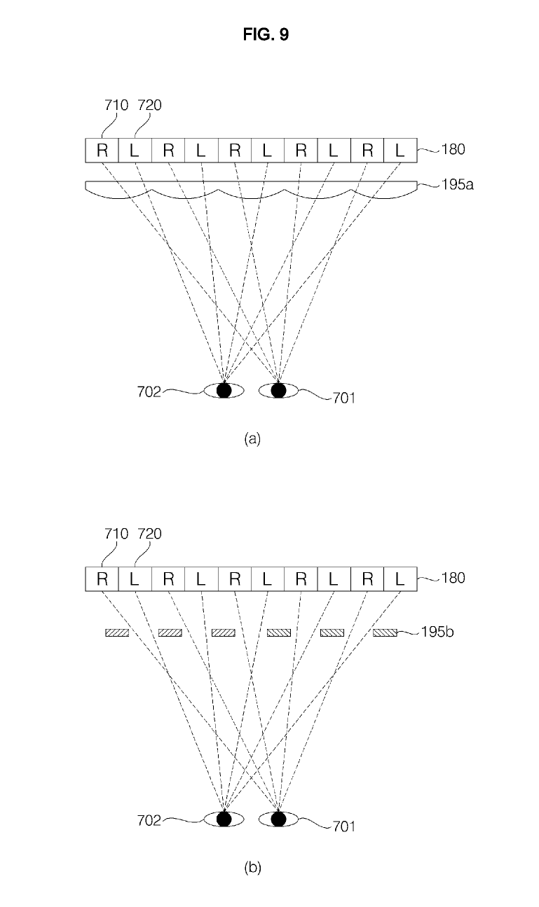

FIG. 9 is a view referred to for describing the principle of a glassless stereoscopic image display apparatus.

The glassless stereoscopic image display apparatus includes a lenticular method and a parallax method as described above and may further include a method of utilizing a microlens array. Hereinafter, the lenticular method and the parallax method will be described in detail. Although a multi-view image includes two images such as a left-eye view image and a right-eye view image in the following description, this is exemplary and the present invention is not limited thereto.

FIG. 9(a) shows a lenticular method using a lenticular lens. Referring to FIG. 9(a), a block 720 (L) configuring a left-eye view image and a block 710 (R) configuring a right-eye view image may be alternately arranged on the display 180. Each block may include a plurality of pixels or one pixel. Hereinafter, assume that each block includes one pixel.

In the lenticular method, a lenticular lens 195a is provided in a lens unit 195 and the lenticular lens 195a provided on the front surface of the display 180 may change a travel direction of light emitted from the pixels 710 and 720. For example, the travel direction of light emitted from the pixel 720 (L) configuring the left-eye view image may be changed such that the light travels toward the left eye 701 of a viewer and the travel direction of light emitted from the pixel 710 (R) configuring the right-eye view image may be changed such that the light travels toward the right eye 702 of the viewer.

Then, the light emitted from the pixel 720 (L) configuring the left-eye view image is combined such that the user views the left-eye view image via the left eye 702 and the light emitted from the pixel 710 (R) configuring the right-eye view image is combined such that the user views the right-eye view image via the right eye 701, thereby viewing a stereoscopic image without wearing glasses.

FIG. 9(b) shows a parallax method using a slit array. Referring to FIG. 9(b), similarly to FIG. 9(a), a pixel 720 (L) configuring a left-eye view image and a pixel 710 (R) configuring a right-eye view image may be alternately arranged on the display 180. In the parallax method, a slit array 195b is provided in the lens unit 195. The slit array 195b serves as a barrier which enables light emitted from the pixel to travel in a predetermined direction. Thus, similarly to the lenticular method, the user views the left-eye view image via the left eye 702 and views the right-eye view image via the right eye 701, thereby viewing a stereoscopic image without wearing glasses.

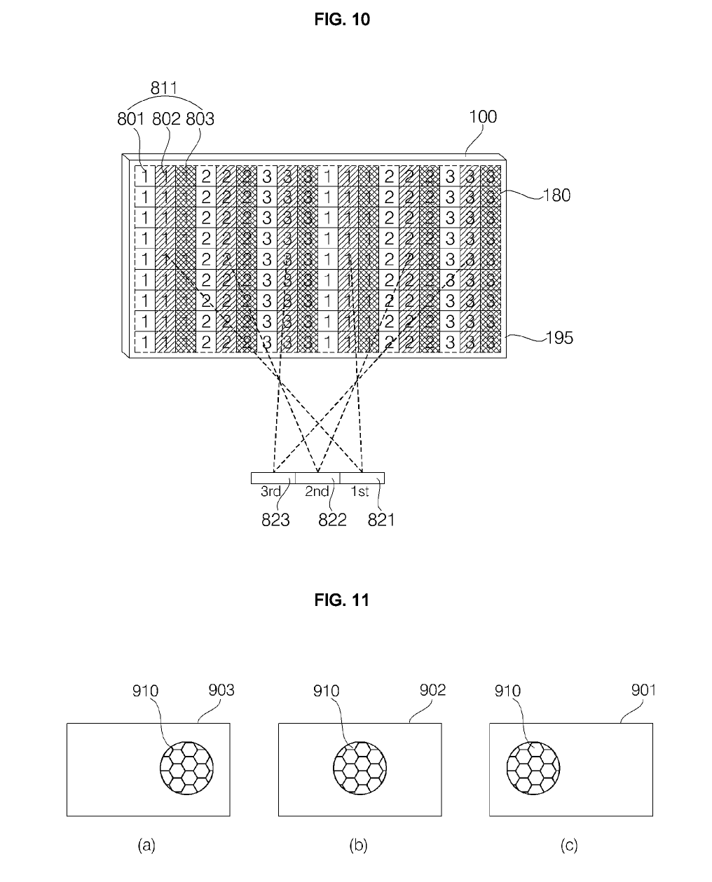

FIGS. 10 to 14 are views referred to for describing the principle of an image display apparatus including multi-view images.

FIG. 10 shows a glassless image display apparatus 100 having three view regions 821, 822 and 823 formed therein. Three view images may be recognized in the three view regions 821, 822 and 823, respectively.

Some pixels configuring the three view images may be rearranged and displayed on the display 180 as shown in FIG. 10 such that the three view images are respectively perceived in the three view regions 821, 822 and 823. At this time, rearranging the pixels does not mean that the physical positions of the pixels are changed, but means that the values of the pixels of the display 180 are changed.

The three view images may be obtained by capturing an image of an object from different directions as shown in FIG. 11. For example, FIG. 11(a) shows an image captured in a first direction, FIG. 11(b) shows an image captured in a second direction and FIG. 11(c) shows an image captured in a third direction. The first, second and third directions may be different.

In addition, FIG. 11(a) shows an image of the object 910 captured in a left direction, FIG. 11(b) shows an image of the object 910 captured in a front direction, and FIG. 11(c) shows an image of the object 910 captured in a right direction.

The first pixel 811 of the display 180 includes a first subpixel 801, a second subpixel 802 and a third subpixel 803. The first, second and third subpixels 801, 802 and 803 may be red, green and blue subpixels, respectively.

FIG. 10 shows a pattern in which the pixels configuring the three view images are rearranged, to which the present invention is not limited. The pixels may be rearranged in various patterns according to the lens unit 195.

In FIG. 10, the subpixels 801, 802 and 803 denoted by numeral 1 configure the first view image, the subpixels denoted by numeral 2 configure the second view image and, and the subpixels denoted by numeral 3 configure the third view image.

Accordingly, the subpixels denoted by numeral 1 are combined in the first view region 821 such that the first view image is perceived, the subpixels denoted by numeral 2 are combined in the second view region 822 such that the second view image is perceived, and the subpixels denoted by numeral 3 are combined in the third view region such that the third view image is perceived.

That is, the first view image 901, the second view image 902 and the third view image 903 shown in FIG. 11 are displayed according to view directions. In addition, the first view image 901 is obtained by capturing the image of the object 910 in a first view direction, the second view image 902 is obtained by capturing the image of the object 910 in a second view direction and the third view image 903 is obtained by capturing the image of the object 910 in a third view direction.

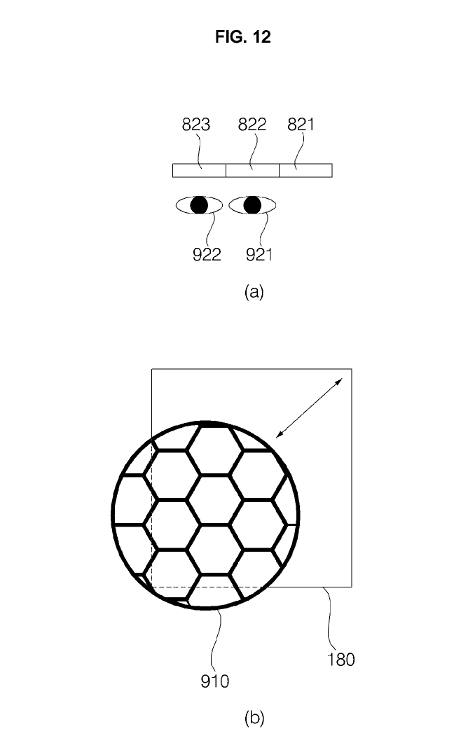

Accordingly, as shown in FIG. 12(a), if the left eye 922 of the viewer is located in the third view region 823 and the right eye 921 of the viewer thereof is located in the second view region 822, the left eye 922 views the third view image 903 and the right eye 921 views the second view image 902.

At this time, the third view image 903 is a left-eye image and the second view image 902 is a right-eye image. Then, as shown in FIG. 12(b), according to the principle described with reference to FIG. 7, the object 910 is perceived as being positioned in front of the display 180 such that the viewer perceives a stereoscopic image without wearing glasses.

In addition, even if the left eye 922 of the viewer is located in the second view region 822 and the right eye 921 thereof is located in the first view region 821, the stereoscopic image (3D image) may be perceived.

As shown in FIG. 10, if the pixels of the multi-view images are rearranged only in a horizontal direction, horizontal resolution is reduced to 1/n (n being the number of multi-view images) that of a 2D image. For example, the horizontal resolution of the stereoscopic image (3D image) of FIG. 10 is reduced to ⅓ that of a 2D image. In contrast, vertical resolution of the stereoscopic image is equal to that of the multi-view images 901, 902 and 903 before rearrangement.

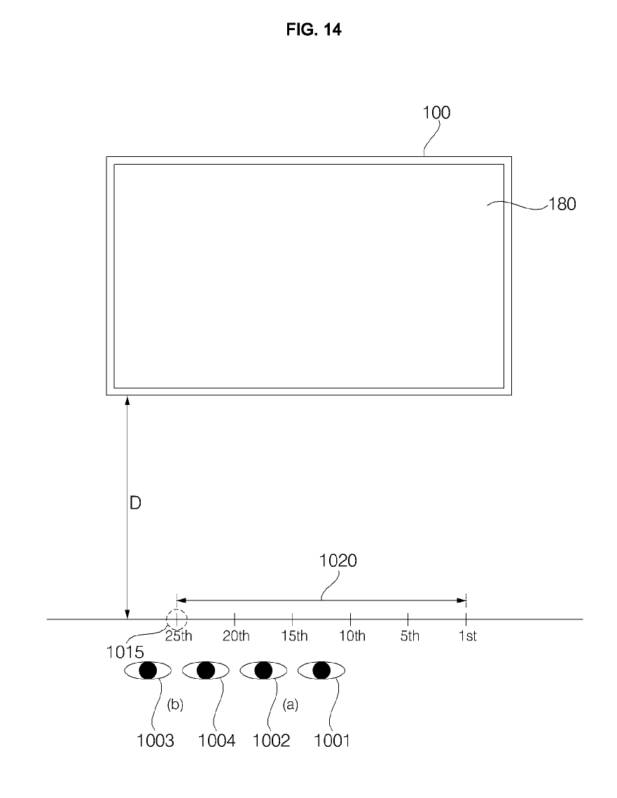

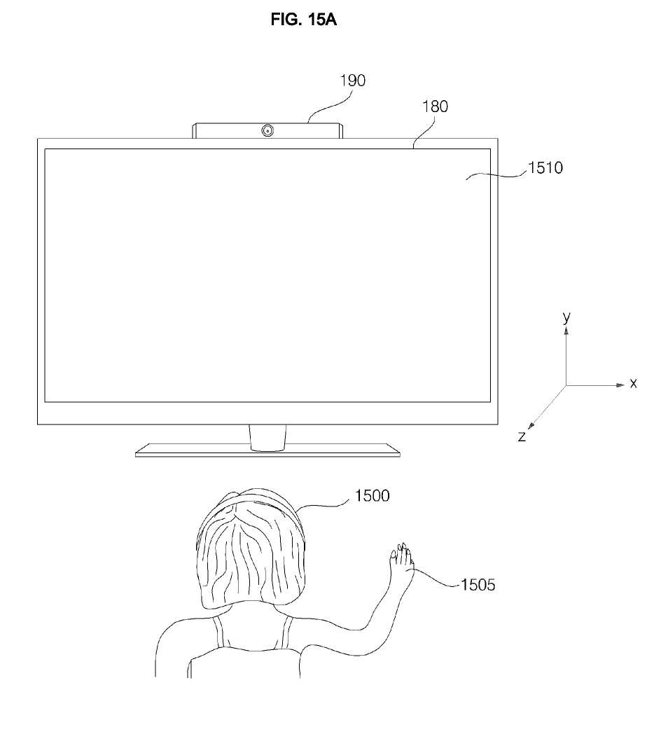

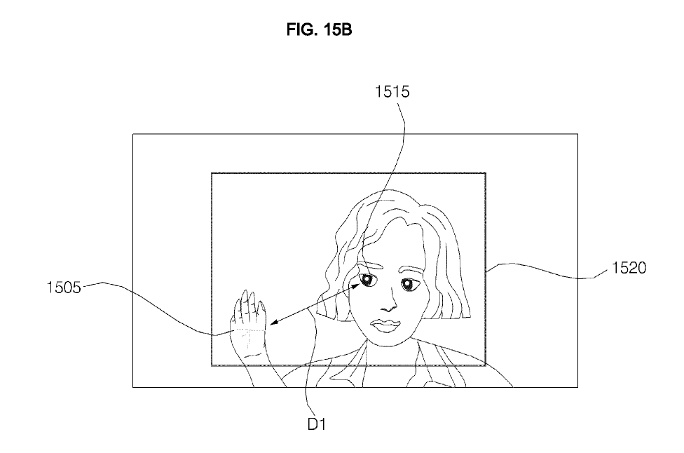

If the number of per-direction view images is large (the reason why the number of view images is increased will be described below with reference to FIG. 14), only horizontal resolution is reduced as compared to vertical resolution and resolution imbalance is severe, thereby degrading overall quality of the 3D image.

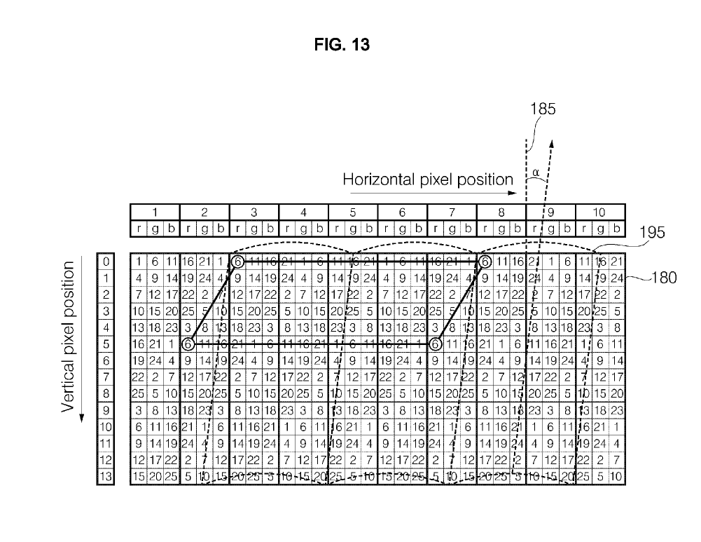

In order to solve such a problem, as shown in FIG. 13, the lens unit 195 may be placed on the front surface of the display 180 to be inclined with respect to a vertical axis 185 at a predetermined angle α and the subpixels configuring the multi-view images may be rearranged in various patterns according to the inclination angle of the lens unit 195. FIG. 13 shows an image display apparatus including 25 multi views according to directions as an embodiment of the present invention. At this time, the lens unit 195 may be a lenticular lens or a slit array.

As described above, if the lens unit 195 is inclined, as shown in FIG. 13, a red subpixel configuring a sixth view image appears at an interval of five pixels in horizontal and vertical directions and horizontal and vertical resolutions may be reduced to ⅕ the vertical resolution of the per-direction multi-view images before rearranging the stereoscopic image (3D image). Accordingly, as compared to the conventional method of reducing only horizontal resolution to 1/25, resolution is uniformly degraded in both directions.

FIG. 14 is a diagram illustrating a sweet zone and a dead zone which appear on a front surface of an image display apparatus.

If a stereoscopic image is viewed using the above-described image display apparatus 100, plural viewers who do not wear special stereoscopic glasses may perceive the stereoscopic effect, but a region in which the stereoscopic effect is perceived is limited.

There is a region in which a viewer may view an optimal image, which may be defined by an optimum viewing distance (OVD) D and a sweet zone 1020. First, the OVD D may be determined by a disparity between a left eye and a right eye, a pitch of a lens unit and a focal length of a lens.

The sweet zone 1020 refers to a region in which a plurality of view regions is sequentially located to enable a viewer to ideally perceive the stereoscopic effect. As shown in FIG. 14, if the viewer is located in the sweet zone 1020 (a), a right eye 1001 views twelfth to fourteenth view images and a left eye 1002 views seventeenth to nineteenth view images such that the left eye 1002 and the right eye 1001 sequentially view the per-direction view images. Accordingly, as described with reference to FIG. 12, the stereoscopic effect may be perceived through the left eye image and the right eye image.

In contrast, if the viewer is not located in the sweet zone 1020 but is located in the dead zone 1015 (b), for example, a left eye 1003 views first to third view images and a right eye 1004 views 23^{rd} to 25^{th} view images such that the left eye 1003 and the right eye 1004 do not sequentially view the per-direction view images and the left-eye image and the right-eye image may be reversed such that the stereoscopic effect is not perceived. In addition, if the left eye 1003 or the right eye 1004 simultaneously view the first view image and the 25^{th} view image, the viewer may feel dizzy.

The size of the sweet zone 1020 may be determined by the number n of per-direction multi-view images and a distance corresponding to one view. Since the distance corresponding to one view must be smaller than a distance between both eyes of a viewer, there is a limitation in distance increase. Thus, in order to increase the size of the sweet zone 1020, the number n of per-direction multi-view images is preferably increased.

FIGS. 15a and 15b are views referred to for describing a user gesture recognition principle.

FIG. 15a shows the case in which a user 500 makes a gesture of raising a right hand while viewing a broadcast image 1510 of a specific channel via the image display apparatus 100.

The camera unit 190 of the image display apparatus 100 captures an image of the user. FIG. 15b shows the image 1520 captured using the camera unit 190. The image 1520 captured when the user makes the gesture of raising the right hand is shown.

The camera unit 190 may continuously capture the image of the user. The captured image is input to the controller 170 of the image display apparatus 100.

The controller 170 of the image display apparatus 100 may receive an image before the user raises the right hand via the camera unit 190. In this case, the controller 170 of the image display apparatus 170 may determine that no gesture is input. At this time, the controller 170 of the image display apparatus 100 may perceive only the face (1515 of FIG. 15b) of the user.

Next, the controller 170 of the image display apparatus 100 may receive the image 1520 captured when the user makes the gesture of raising the right hand as shown in FIG. 15b.

In this case, the controller 170 of the image display apparatus 100 may measure a distance between the face (1515 of FIG. 15b) of the user and the right hand 1505 of the user and determine whether the measured distance D1 is equal to or less than a reference distance Dref. If the measured distance D1 is equal to or less than the reference distance Dref, a predetermined first hand gesture may be recognized.

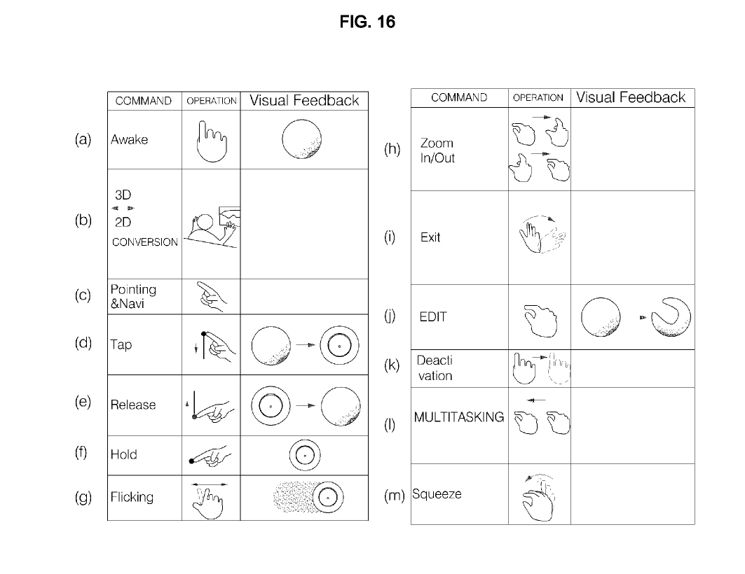

FIG. 16 shows operations corresponding to user gestures. FIG. 16(a) shows an awake gesture corresponding to the case in which a user points one finger for N seconds. Then, a circular object may be displayed on a screen and brightness may be changed until the awake gesture is recognized.

Next, FIG. 16(b) shows a gesture of converting a 3D image into a 2D image or converting a 2D image into a 3D image, which corresponds to the case in which a user raises both hands to a shoulder height for N seconds. At this time, depth may be adjusted according to the position of the hand. For example, if both hands move toward the display 180, the depth of the 3D image may be decreased, that is, the 3D image reduced and, if both hands move in the opposite direction of the display 180, the depth of the 3D image may be increased, that is, the 3D image expanded, and vice versa. Conversion completion or depth adjustment completion may be signaled by a clenched fist. Upon a gesture of FIG. 16(b), a glow effect in which an edge of the screen is shaken while a displayed image is slightly lifted up may be generated. Even during depth adjustment, a semi-transparent plate may be separately displayed to provide the stereoscopic effect.

Next, FIG. 16(c) shows a pointing and navigation gesture, which corresponds to the case in which a user relaxes and inclines his/her wrist at 45 degrees in a direction of an XY axis.

Next, FIG. 16(d) shows a tap gesture, which corresponds to the case in which a user unfolds and slightly lowers one finger in a Y axis within N seconds. Then, a circular object is displayed on a screen. Upon tapping, the circular object may be enlarged or the center thereof may be depressed.

Next, FIG. 16(e) shows a release gesture, which corresponds to the case in which a user raises one finger in a Y axis within N seconds in a state of unfolding one finger. Then, a circular object modified upon tapping may be restored on the screen.

Next, FIG. 16(f) shows a hold gesture, which corresponds to the case in which tapping is held for N seconds. Then, the object modified upon tapping may be continuously held on the screen.

Next, FIG. 16(g) shows a flick gesture, which corresponds to the case in which the end of one finger rapidly moves by N cm in an X/Y axis in a pointing operation. Then, a residual image of the circular object may be displayed in a flicking direction.

Next, FIG. 16(h) shows a zoom-in or zoom-out gesture, wherein a zoom-in gesture corresponds to a pinch-out gesture of spreading a thumb and an index finger and a zoom-out gesture corresponds to a pinch-in gesture of pinching a thumb and an index finger. Thus, the screen may be zoomed in or out.

Next, FIG. 16(i) shows an exit gesture, which corresponds to the case in which the back of a hand is swiped from the left to the right in a state in which all fingers are unfolded. Thus, the OSD on the screen may disappear.

Next, FIG. 16(j) shows an edit gesture, which corresponds to the case in which a pinch operation is performed for N seconds or more. Thus, the object on the screen may be modified to feel as if the object is pinched.

Next, FIG. 16(k) shows a deactivation gesture, which corresponds to an operation of lowering a finger or a hand. Thus, the hand-shaped pointer may disappear.

Next, FIG. 16(l) shows a multitasking gesture, which corresponds to an operation of moving the pointer to the edge of the screen and sliding the pointer from the right to the left in a pinched state. Thus, a portion of the edge of a right lower end of the displayed screen is lifted up as would be a piece of paper. Upon selection of a multitasking operation, a screen may be turned as if pages of a book are turned.

Next, FIG. 16(m) shows a squeeze gesture, which corresponds to an operation of folding all five unfolded fingers. Thus, icons/thumbnails on the screen may be collected or only selected icons may be collected upon selection.

FIG. 16 shows examples of the gesture and various additional gestures or other gestures may be defined.

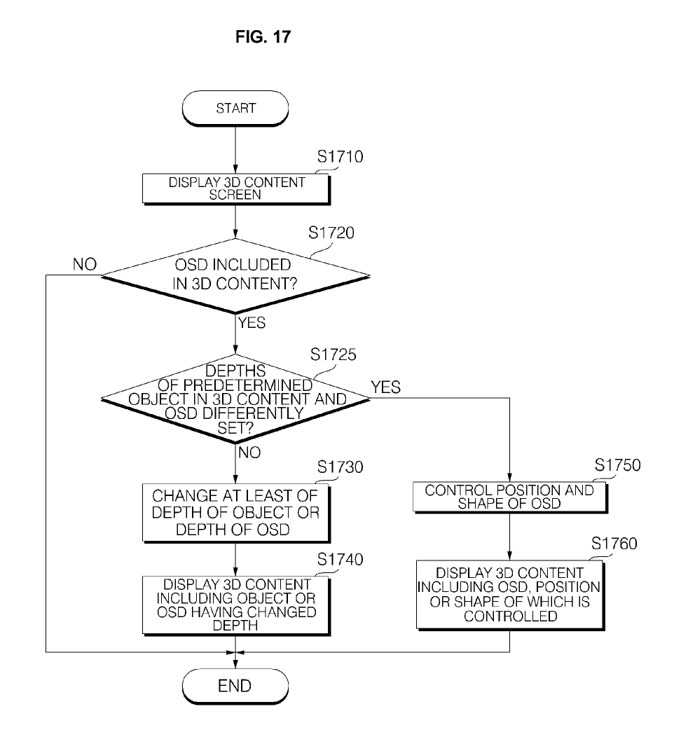

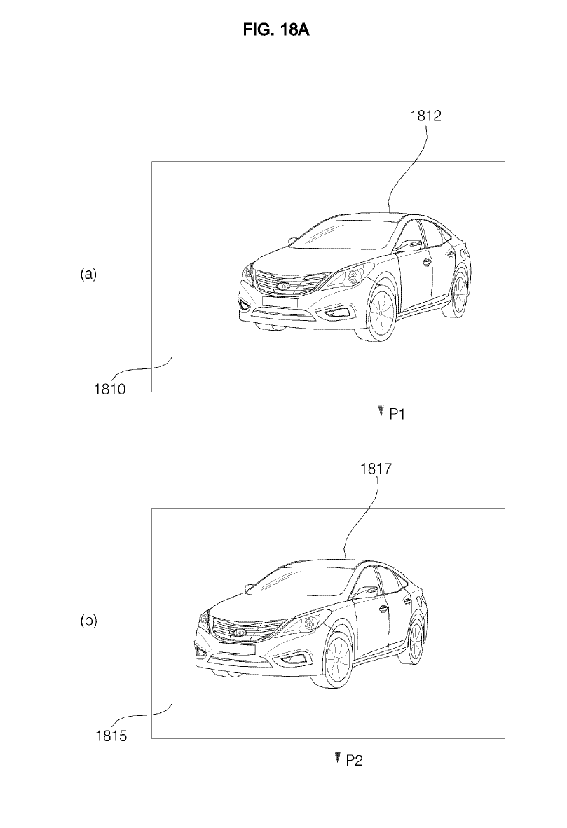

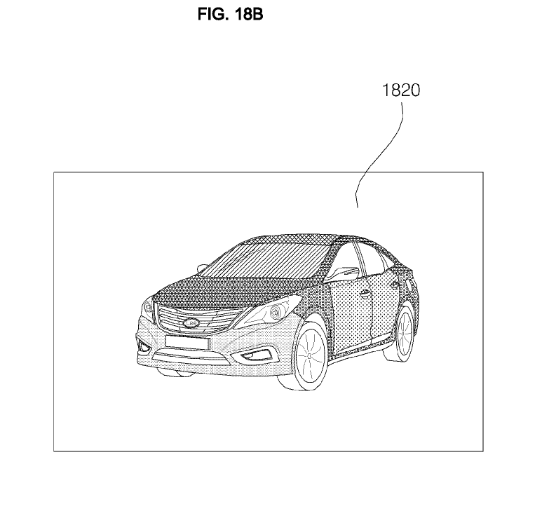

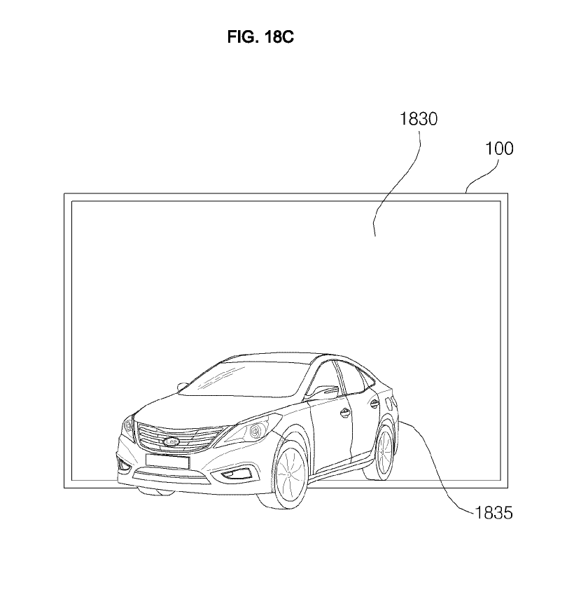

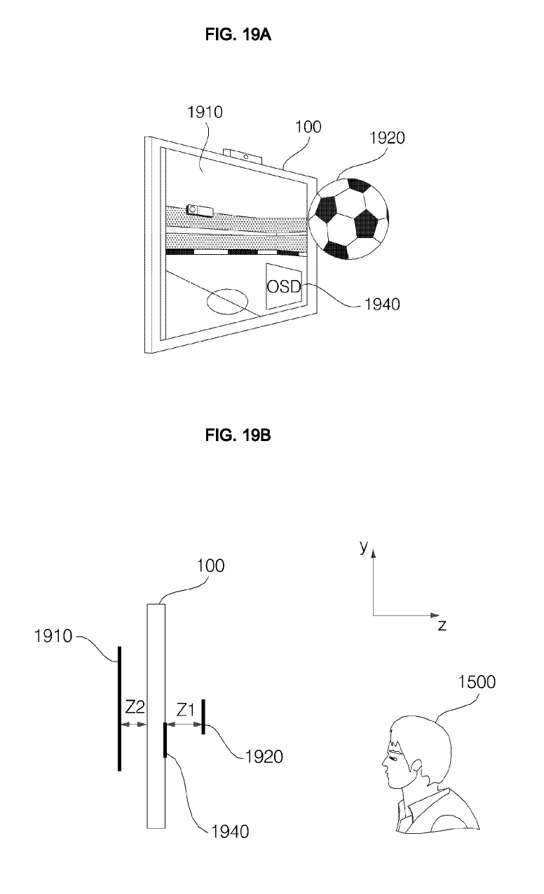

FIG. 17 is a flowchart illustrating a method for operating an image display apparatus according to an embodiment of the present invention, and FIGS. 18a to 26 are views referred to for describing various examples of the method for operating the image display apparatus of FIG. 17.

First, referring to FIG. 17, the display 180 of the image display apparatus 100 displays a 3D content screen (S1710).

The 3D content screen display according to the embodiment of the present invention may be a glassless 3D image display as described above. If 3D content screen display input is received, the camera 190 of the image display apparatus 100 captures an image of a user and sends the captured image to the controller 170.

The controller 170 detects the distance and position of the user based on the captured image. For example, the distance (z-axis position) of the user may be measured by comparing the pupils of the user and the resolution of the captured image and the position (y-axis position) of the user may be detected according to the user position in the captured image.

Then, the controller 170 arranges multi-view images corresponding to a 3D content screen in consideration of the position of the user and, more particularly, the positions and distances of the left and right eyes of the user.

The display 180 displays the multi-view images arranged by the controller 170 and second power is applied to the lens unit 195 to scatter the multi-view images such that the left eye of the user recognizes a left-eye image and the right eye of the user recognizes a right-eye image.

FIG. 18a shows a left-eye image 1810 including a predetermined object 1812 of FIG. 18a(a) and a right-eye image 1815 including a predetermined object 1817 of FIG. 18a(b) as an example of a 3D content image. The position of the object 1812 in the left-eye image 1810 is P1 and the position of the object 1817 in the right-eye image 1815 is P2. That is, disparity occurs.

FIG. 18b shows a depth image 1820 or a depth map based on disparity between the left-eye image 1810 and the right-eye image 1815. Hatching of FIG. 18b denotes a luminance difference and depth varies according to luminance difference.

Using such a depth image 192, the image display apparatus 100 may display 3D content. That is, as described above, using a glassless method, the left eye of the user recognizes the left-eye image 1810 and the right eye thereof recognizes the right-eye image 1815. As shown in FIG. 18c, the user recognizes a 3D image 1830 from which an object 1835 protrudes.

The controller 170 of the image display apparatus 100 determines whether an on screen display (OSD) is included in the 3D content screen (S1720). If so, whether the depth of a predetermined object in the 3D content screen and the depth of the OSD are differently set is determined (S1725). If so, at least one of the depth of the predetermined object in the 3D content screen or the depth of the OSD is changed (S1730). Then, the display 180 of the image display apparatus 100 displays a 3D content screen including the object or OSD having the changed depth (S1740).

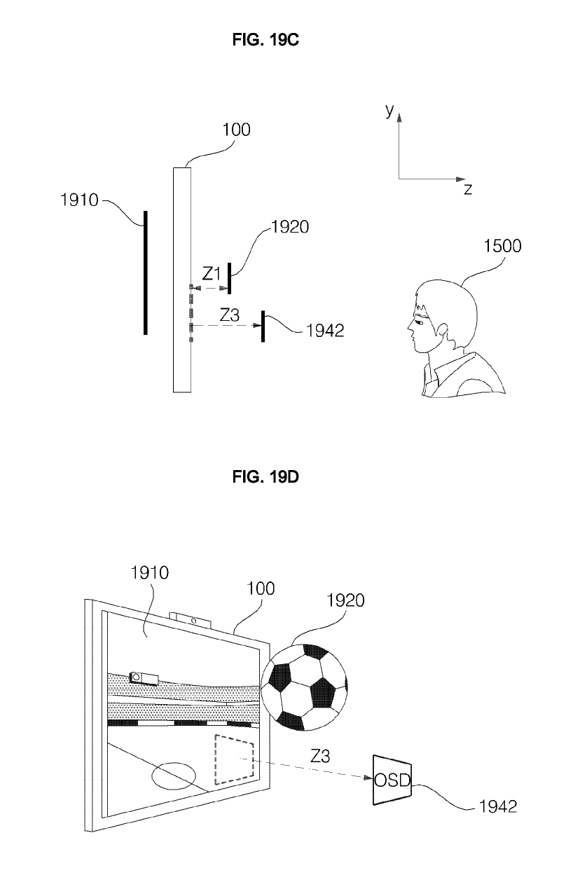

FIG. 19a shows an example of a 3D content screen. An object protruding from the display 180 is referred to as a foreground object and an object located behind the display 180 is referred to as a background object.

In the present specification, the depth of the 3D object may be set to a positive value if the object protrudes from the display 180 toward the user, may be set to 0 if the object is displayed on the display 180, and may be set to a negative value if the object is located behind the display 180.

In the present specification, the OSD is an object separately generated in the image display apparatus 100 and includes text, menus, icons, widgets, etc. Hereinafter, an object included in an input image and OSD separately generated in the image display apparatus 100 are distinguished.

In FIG. 19a, a 3D content screen includes a background 1910 and a foreground object 1920. If OSD needs to be displayed by user manipulation, the OSD 1940 with a depth value of 0 may be displayed on the display 180.

In this case, the user mainly recognizes the protruding foreground object 1920 and readability of the OSD 1940 separately generated in the image display apparatus 100 may decrease.

FIG. 19b is a side view of FIG. 19a, which shows the depths of the background 1910, the foreground object 1920 and the OSD 1940 in the 3D content screen.

Referring to FIG. 19b, the background 1910 has a depth value of −z2, the foreground object 1920 has a depth value of +z1 and the OSD 1940 has a depth value of 0.

In the embodiment of the present invention, in order to improve readability of the OSD, at least one of the depth of a predetermined object in the 3D content screen or the depth of the OSD is changed.

More specifically, (1) the depth of the object in the 3D content screen may not be changed and the depth of the OSD may be changed such that the depth of the OSD is greater than any other object in the 3D content screen, (2) the depth of the object in the 3D content screen may be reduced to scale and the depth of the OSD may be changed such that the depth of the OSD is greater than the reduced depth of the object, or (3) the depth of the object in the 3D content screen may be reduced by a predetermined depth and the depth of the OSD may be changed such that the depth of the OSD is greater than the reduced depth of the object.

FIGS. 19c and 19d show the case of (1) as a depth changing method.

That is, the controller 170 may extract an object having a maximum depth of 3D content via a depth map of the 3D content shown in FIG. 18b.

Then, the controller 170 does not change the depth of the object in the 3D content screen and changes the depth of the OSD such that the depth of the OSD is greater than the depth of any other object in the 3D content screen.

In FIG. 19c, the depth of the OSD 1942 is Z3, which is greater than the depth z1 of the foreground object 1920.

As shown in FIG. 19d, the user 1500 may recognize the OSD 1942 as protruding from the background 1910 and the foreground object 1920 in the 3D content. As a result, readability of the OSD 1942 is improved.

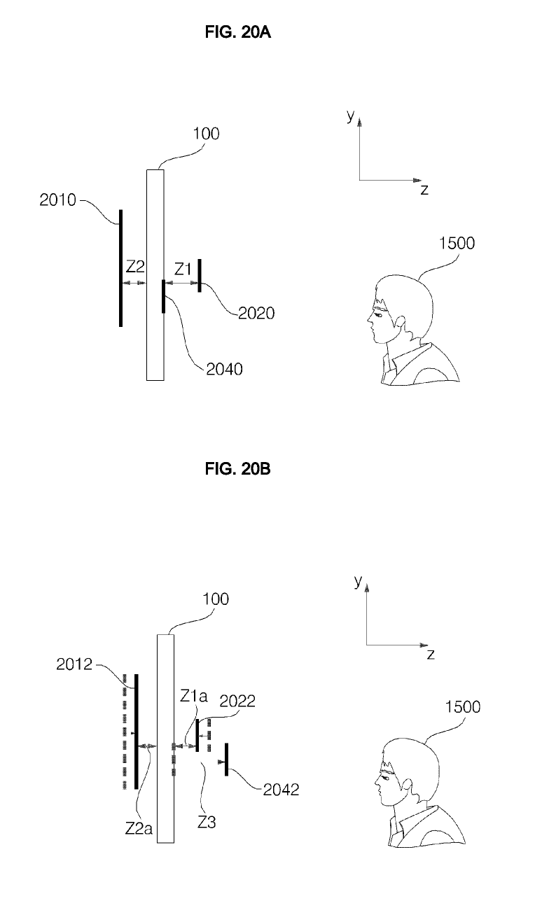

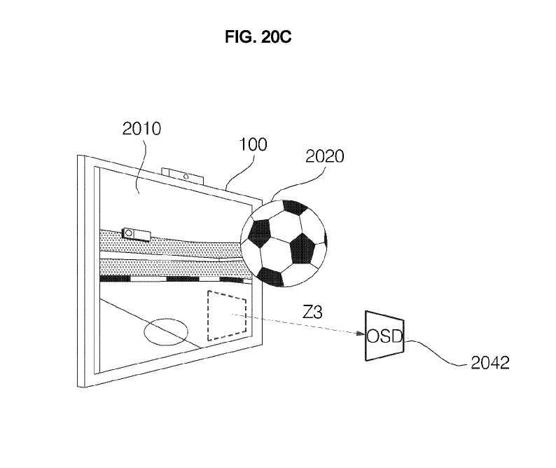

Next, FIGS. 20a to 20c show case of (2) as a depth changing method.

In FIG. 20a, similarly to FIG. 19b, the background 2010 in the 3D content screen has a depth value of −z2, the foreground object 2020 has a depth value of +z1, and the OSD 2040 has a depth of 0.

The controller 170 reduces the depth of the object in the 3D content screen to scale and changes the depth of the OSD such that the depth of the OSD is greater than the reduced depth of the object.

FIG. 20b shows reduction of the depth values of the background and the foreground object in the 3D content to scale. For example, the depth values of the background and the foreground object in the 3D content are multiplied by a value of 0.7 such that both the depth values of the background and the foreground object in the 3D content are reduced.

FIG. 20b shows the state in which the depth of the background 201 is changed from z2 to z2a and the depth of the foreground object 2022 is changed from z1 to z1a. Thus, the depth value of the background 2012 may increase and the depth value of the foreground object 2022 may decrease. That is, the depth range in the 3D content may be reduced as shown.

The OSD 2042 may be set to have a depth value greater than the background 2012 and foreground object 2022 in the 3D content, the depths of which are reduced to scale. In the figure, the depth of the OSD 2042 is Z3, which is greater than the depth z1a of the foreground object 2022.

As shown in FIG. 20c, the user 1500 may recognize the OSD 2042 as protruding from the background 2010 and the foreground object 2020 in the 3D content, the depths of which are reduced to scale. As a result, the readability of the OSD 2042 is improved.

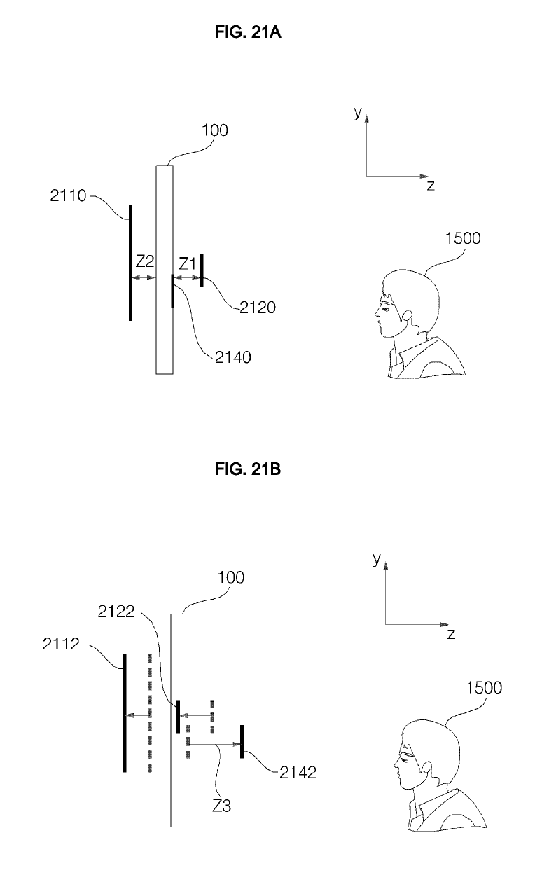

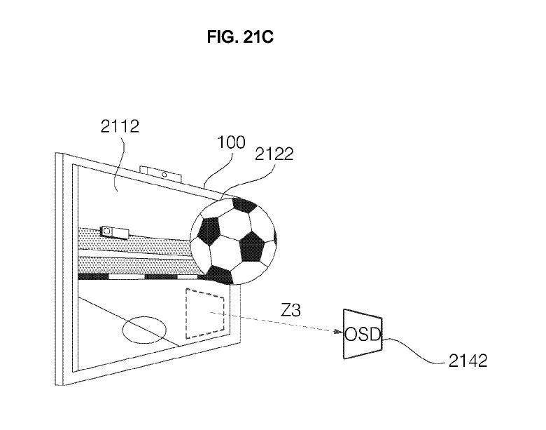

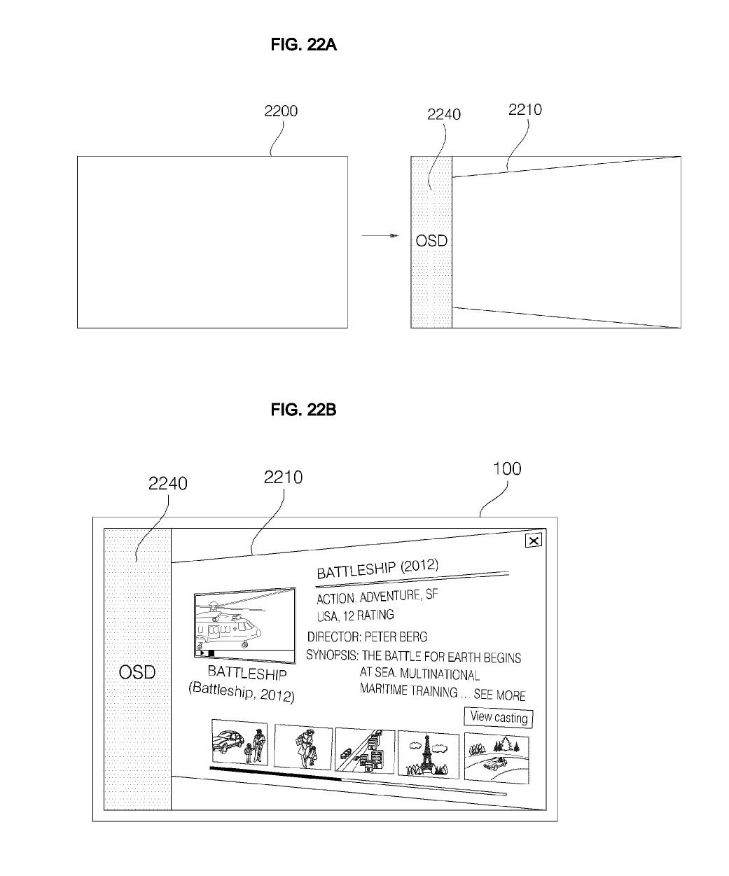

Next, FIGS. 21a to 21c show case of (3) as a depth changing method.

In FIG. 21a, similarly to FIG. 19b, the background 2110 in the 3D content screen has a depth value of −z2, the foreground object 2120 has a depth value of +z1, and the OSD 2140 has a depth of 0.

The controller 170 reduces the depth of the object in the 3D content screen by a predetermined depth and changes the depth of the OSD such that the depth of the OSD is greater than the reduced depth of the object.

FIG. 21b shows reduction of the depth values of the background 2112 and the foreground object 2122 in the 3D content by the predetermined value. For example, a depth value of +3 may be subtracted from the depth values of the background and the foreground object in the 3D content such that both the depth values of the background 2122 and the foreground object 2122 in the 3D content are reduced.

FIG. 21b shows the state in which the depth values of the background 2112 and the foreground object 2122 in the 3D content are reduced by the predetermined value. For example, the depth value of +3 may be subtracted from the depth values of the background and the foreground object in the 3D content such that both the depth values of the background 2112 and the foreground object 2122 in the 3D content are reduced.

FIG. 21b shows the state in which the depth of the background 2112 is changed from z2 to 0 and the depth of the foreground object 2122 is changed to be less than z1. That is, both the depth values of the background and the foreground object in the 3D content may be reduced by the predetermined depth value.

The OSD 2042 may be set to have a depth greater than the reduced depth values of the background 2112 and the foreground object 2142 in the 3D content. In the figure, the depth of the OSD 2142 is Z3, which is greater than the depth 0 of the foreground object 2122.

As shown in FIG. 21c, the user 1500 may recognize the OSD 2042 as protruding from the background 2112 and the foreground object 2122 in the 3D content, the depths of which are reduced by the predetermined depth value. As a result, readability of the OSD 2042 is improved.

If the depth of the predetermined object in the 3D content screen and the depth of the OSD are set to be equal in step S1725, step S1750 is performed. That is, the controller 170 of the image display apparatus 100 controls at least one of the position or shape of the OSD. The display 180 of the image display apparatus 100 displays 3D content including the OSD, the position or shape of which is controlled (S1760).

In the embodiment of the present invention, in order to improve readability of the OSD, if the depth of the predetermined object in the 3D content screen and the depth of the OSD are set to be equal, at least one of the position or shape of the OSD is changed.

More specifically, (4) a 3D content screen or an object in the 3D content screen may be tilted or (5) the position of the OSD may be changed such that the OSD does not overlap the object in the 3D content screen.

FIGS. 22a to 22b show case of (4) as a method of changing the shape of the OSD.

FIG. 22a shows a 3D content image 2200. Although a 2D image is displayed in FIG. 22a, 3D content may be displayed.

If an OSD needs to be displayed when the 3D content image 2200 is displayed, the controller 170 may tilt the 3D content image 2200 by a predetermined angle in order to improve readability of the OSD. The 3D content image is changed from a rectangle to a trapezoid, thereby improving 3D effect.

FIG. 22a shows the state in which the tilted 3D content image 2210 is provided in an area which does not overlap the OSD 2240 to be displayed.

As shown in FIG. 22b, the image display apparatus 100 may display an image 2200 including the tilted 3D content image 2210 and the OSD 2240. At this time, since the OSD 2240 is not tilted, the OSD may be distinguished from the tilted 3D content image 2210. Thus, it is possible to improve readability of the OSD 2240.

Unlike the figure, the 3D content image 2200 may not be changed but the OSD 2240 may be tilted.

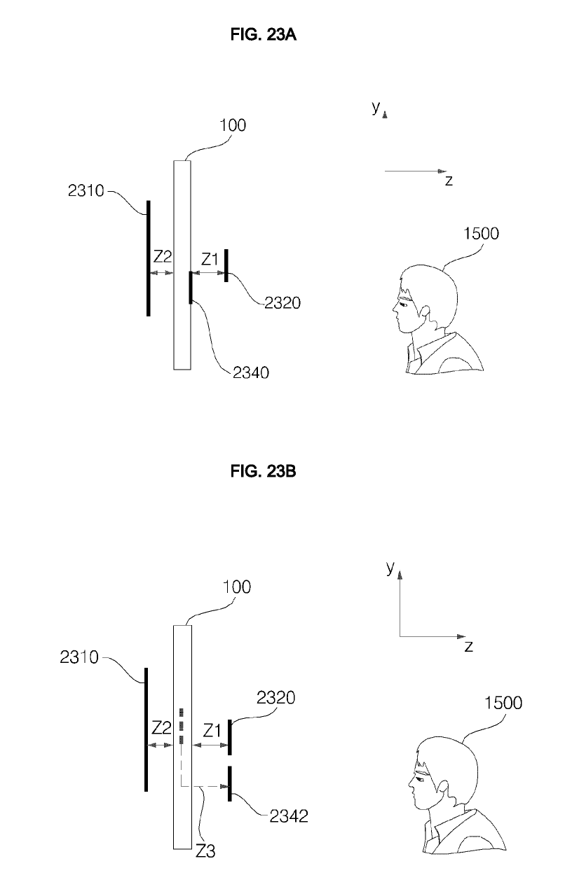

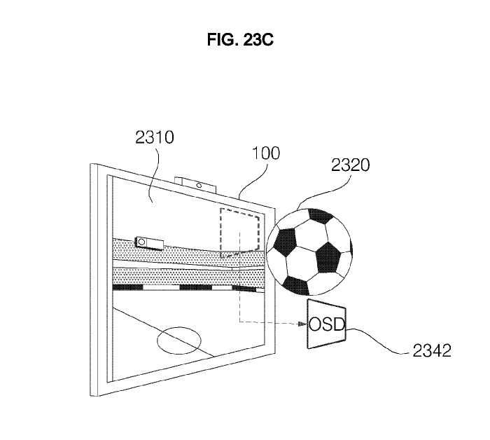

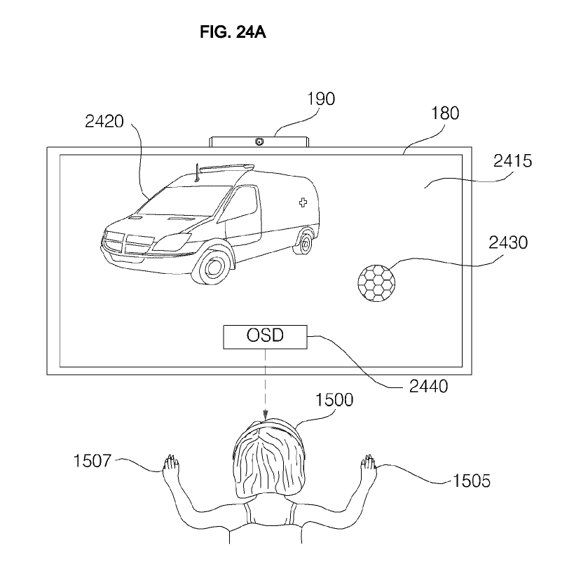

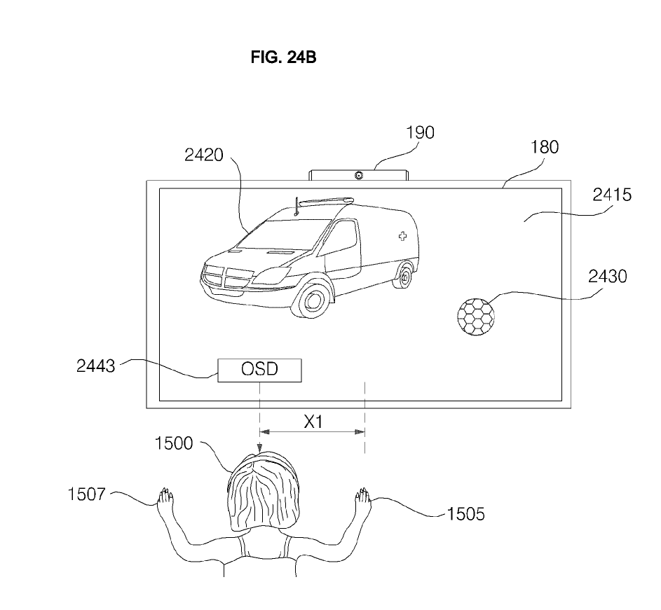

Next, FIGS. 23a to 23c show case of (5) as a method of changing the position of the OSD.

In FIG. 23a, similarly to FIG. 19b, the background 2310 in the 3D content screen has a depth value of −z2, the foreground object 2320 has a depth value of +z1, and the OSD 2340 has a depth value of 0.

At this time, from the viewpoint of the user 1500, the position of the OSD 2340 overlaps the foreground object 2320.

Thus, the controller 170 changes the position of the OSD such that the OSD does not overlap the object in the 3D content screen.

That is, as shown in FIG. 23b, the foreground object 2320 may not be changed and the OSD 2342 may move in a −y axis direction and a +z axis direction. That is, the OSD 2342 may be located below the foreground object 2320 and the depth thereof may be set to z1.

As shown in FIG. 23c, the user 1500 may easily recognize the OSD 2342 by moving the OSD and changing the depth of the OSD. As a result, it is possible to improve readability of the OSD 2342.

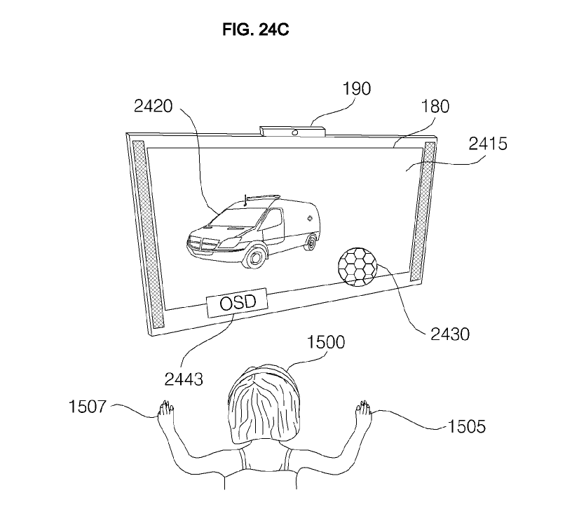

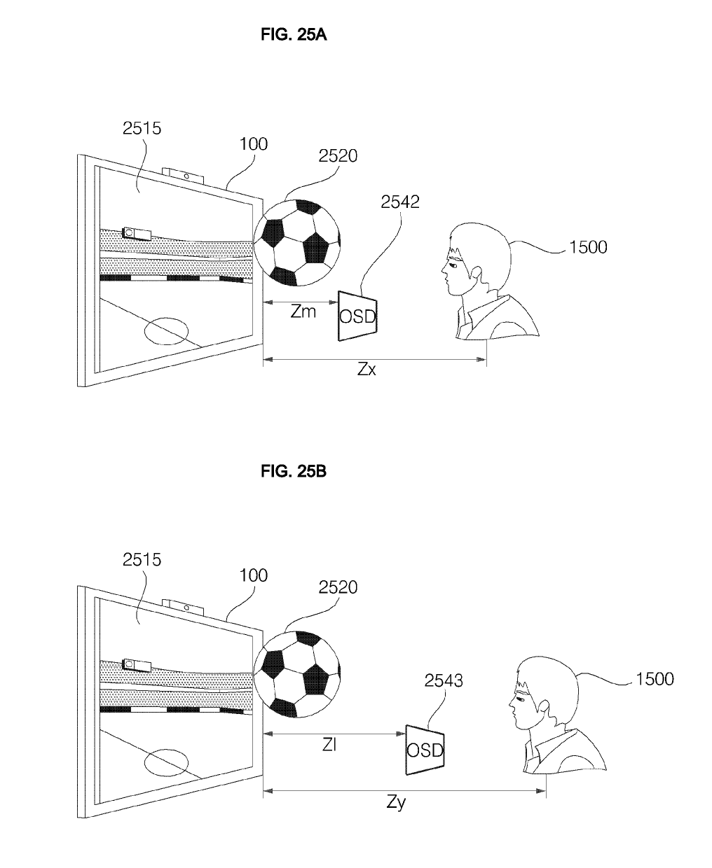

FIGS. 24a to 24c show another example for improving readability of the OSD.

Upon display of 3D content, the position of the displayed OSD may be changed according to the position of the user.

The controller 170 may detect the position, that is, the x-axis position, of the user based on the image captured by the camera 190 and control display of the OSD in correspondence with the detected x-axis position.

FIG. 24a shows the state in which a 3D content screen 2415 including a plurality of objects 2420 and 2430 is displayed and the OSD 2440 is displayed at the center of the screen so as not to overlap the objects 2420 and 2430 because the user 1500 is located at the center of the screen.

The 3D content screen 2415 may be displayed by a 3D content conversion gesture of FIG. 16(b).

In FIG. 24b, since the position of the user 1500 moves to the left as compared to FIG. 24a, when the 3D content screen 2415 including the plurality of objects 2420 and 2430 is displayed, the OSD 2443 moves to the left side of the screen so as not to overlap the objects 2420 and 2430.

As a result, as shown in FIG. 24c, the user may easily recognize the OSD 2443, the position of which is changed according to the position of the user. As a result, it is possible to improve readability of the OSD 2443.

Any one of the methods of FIGS. 19a to 23c may be combined with the method of changing the position of the OSD shown in FIG. 24b.

FIGS. 25a to 25b show another example for improving readability of the OSD.

When 3D content is displayed, the position of the displayed OSD may be changed according to the position of the user.

The controller 170 may detect the distance, that is, the z-axis position, of the user based on the image captured by the camera 190 and control display of the OSD in correspondence with the detected z-axis position.

More specifically, the controller 170 may increase the depth of the displayed OSD as the distance of the user increases.

FIG. 25a shows the state in which OSD 2542 is displayed as protruding from a background 2515 and a foreground object 2520 if the distance of the user is a first distance Zx. The depth of the OSD 2542 may be set to zm.

FIG. 25b shows the state in which OSD 2543 is displayed as protruding from a background 2515 and a foreground object 2520 if the distance of the user is a second distance Zy. The depth of the OSD 2542 may be set to z1.

In comparison between FIGS. 25b and 25a, the depth of the displayed OSD increases as the distance of the user increases.

As a result, as shown in FIG. 25b, the user 1500 may easily recognize the OSD 2543, the depth of which is changed according to the distance of the user. As a result, it is possible to improve readability of the OSD 2543.

Any one of the methods of FIGS. 22a to 23c may be combined with the method of changing the depth of the OSD shown in FIG. 25b.

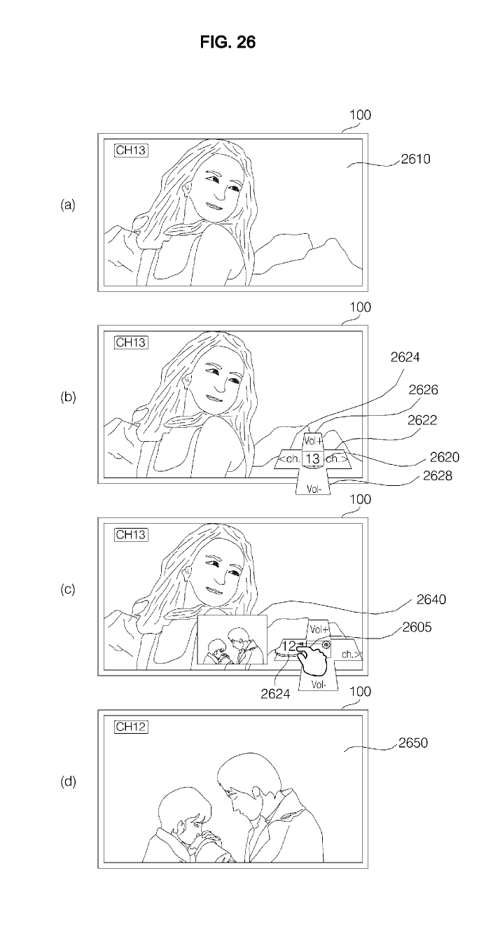

FIG. 26 shows channel control or volume control based on a user gesture.

First, FIG. 26 shows display of a predetermined content screen 2610. The predetermined content screen 2610 may be a 2D image or a 3D image.

Next, if predetermined user input is received, a channel control or volume control object 2620 may be displayed while viewing content 2610, as shown in FIG. 26(b). This object is generated in the image display apparatus and may be referred to as an OSD 2620.

The predetermined user input may be voice input, button input of a remote controller or user gesture input.

The depth of the displayed OSD 2620 may be greatest or the position of the displayed OSD 2620 may be controlled as described above with reference to FIGS. 19a to 25b, in order to improve readability of the OSD.

In the figure, the displayed OSD 2620 includes channel control items 2622 and 2624 and volume control items 2626 and 2628. The OSD 2620 may be displayed as a 3D image.

Next, FIG. 26(c) shows the case in which a down channel item 2624 is selected from between the channel control items according to a predetermined user gesture. Thus, a preview screen 2630 may also be displayed on the screen.

The controller 170 may control operation corresponding to the predetermined user gesture.

The gesture of FIG. 26(c) may be the pointing and navigation gesture of FIG. 16(c).

FIG. 26(d) shows display of a screen 2650 changed by selecting the down channel item according to the predetermined user gesture. At this time, the user gesture may be the tap gesture of FIG. 16(d).

Accordingly, the user can conveniently perform channel control or volume control.

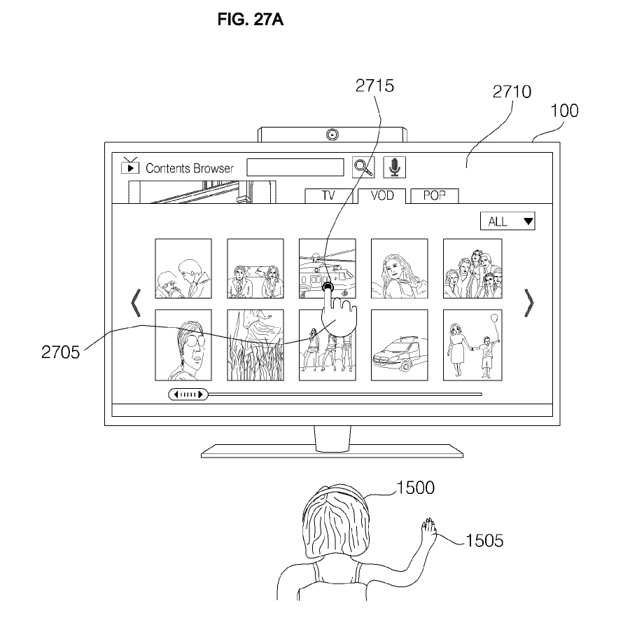

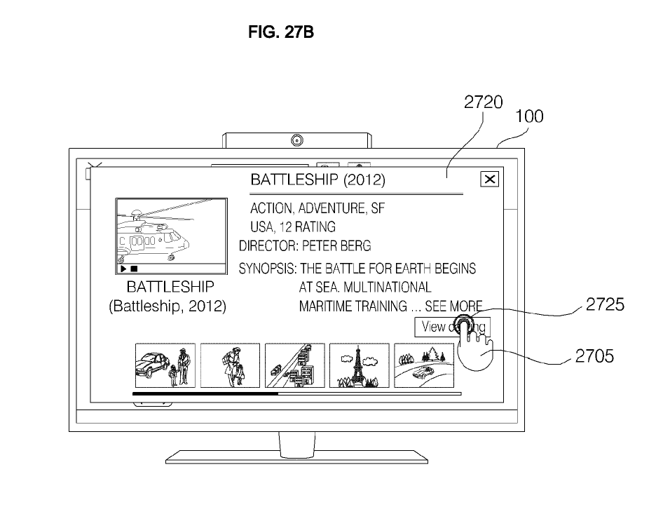

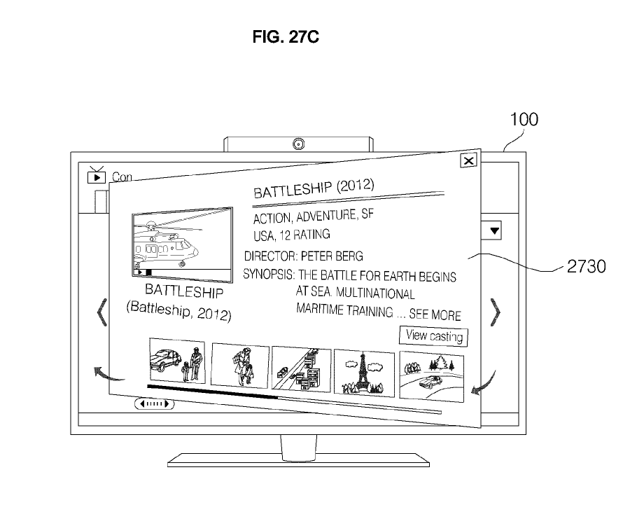

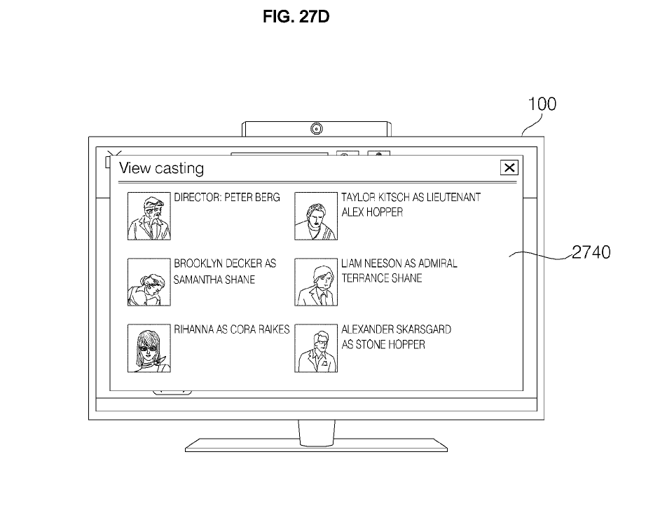

FIGS. 27a to 27c show another example of screen change by a user gesture.

FIG. 27a shows display of a content list 2710 on the image display apparatus 100. If the tap gesture of FIG. 16(d) is performed using a right hand 1505 of the user 1500, an item 2715 on which a hand-shaped pointer 2705 is placed may be selected.

As shown in FIG. 27b, a content screen 2720 may be displayed. At this time, if the tap gesture of FIG. 16(d) is performed using the right hand 1505 of the user 1500, an item 2725 on which the hand-shaped pointer 2705 is placed may be selected.

In this case, as shown in FIG. 27c, while the displayed content screen 2720 rotates, the rotated content screen 2730 may be temporarily displayed and then the screen may be changed such that the screen 2740 corresponding to the selected item 2725 is displayed as shown in FIG. 27d.

As shown in FIG. 27c, if the rotated content screen 2730 is three-dimensionally displayed while rotating, it is possible to increase user readability. Thus, it is possible to increase user concentration on the screen.

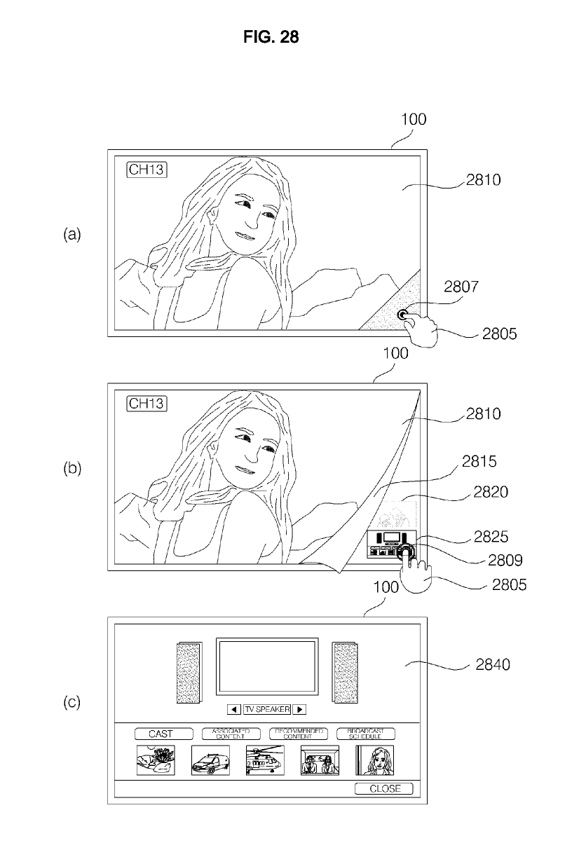

FIG. 28 shows a gesture related to multitasking.

FIG. 28(a) shows display of a predetermined image 2810. At this time, when a user makes a predetermined gesture, the controller 170 senses the user gesture.

If the gesture of FIG. 28(a) is the multitasking gesture of FIG. 16(l), that is, if the pointer 2805 is moved to the screen edge 2807 and then slides from the right to the left in a pinched state, as shown in FIG. 28(b), a portion of the edge of a right lower end of the displayed screen 2810 may be lifted up as though paper were being lifted, and a recent execution screen list 2825 may be displayed on a next surface 2820 thereof. That is, the screen may be turned as if pages of a book are turned.

If the user makes a predetermined gesture, that is, if a predetermined item 2809 of the recent execution screen list 2825 is selected, as shown in FIG. 28(c), a selected recent execution screen 2840 may be displayed. A gesture at this time may correspond to a tap gesture of FIG. 16(d).

As a result, the user may conveniently execute a desired operation without blocking the image viewed by the user.

The recent execution screen list 2825 is an OSD, which may have a greatest depth or may be displayed so as not to overlap another object.

According to an image display apparatus of one embodiment of the present invention, if an OSD is included in a 3D content screen, at least one of a depth of a predetermined object in the 3D content screen or the OSD is changed. Thus, it is possible to ensure readability of the OSD. Accordingly, it is possible to increase user convenience.

According to another embodiment of the present invention, at least one of a position or shape of an OSD is changed. Thus, it is possible to ensure readability of the OSD. Accordingly, it is possible to increase user convenience.

According to another embodiment of the present invention, an image display apparatus is a glassless 3D display apparatus which displays multi-view images on a display according to user position and outputs images corresponding to left and right eyes of a user via a lens unit for separating the multi-view images according to directions. Thus, the user stably can view a 3D image without glasses.

According to another embodiment of the present invention, an image display apparatus can recognize a user gesture based on an image captured by a camera and perform operation based on the recognized user gesture. It is possible to increase user convenience.

The image display apparatus and the method for operating the same according to the foregoing embodiments are not restricted to the embodiments set forth herein. Therefore, variations and combinations of the exemplary embodiments set forth herein may fall within the scope of the present invention.

The method for operating an image display apparatus according to the foregoing embodiments may be implemented as code that can be written to a computer-readable recording medium and can thus be read by a processor. The computer-readable recording medium may be any type of recording device in which data can be stored in a computer-readable manner. Examples of the computer-readable recording medium include a ROM, a RAM, a CD-ROM, a magnetic tape, a floppy disk, optical data storage, and a carrier wave (e.g., data transmission over the Internet). The computer-readable recording medium may be distributed over a plurality of computer systems connected to a network so that computer-readable code is written thereto and executed therefrom in a decentralized manner. Functional programs, code, and code segments to realize the embodiments herein can be construed by one of ordinary skill in the art.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image display apparatus comprising:
a camera configured to capture image;
a display configured to display a three-dimensional content screen; and
a controller configured to change at least one of a depth of a predetermined object in the 3D content screen or an on screen display (OSD) if the OSD is included in the 3D content screen,
wherein the display displays a 3D content screen including the object or OSD having the changed depth.

2. The image display apparatus according to claim 1, wherein the controller does not change the depth of the object in the 3D content screen and changes the depth of the OSD such that the depth of the OSD is greater than the depth of the object in the 3D content screen,
reduces the depth of the object in the 3D content screen to scale and changes the depth of the OSD such that the depth of the OSD is greater than the reduced depth of the object in the 3D content screen, or
reduces the depth of the object in the 3D content screen by a predetermined depth and changes the depth of the OSD such that the depth of the OSD is greater than the reduced depth of the object in the 3D content screen.

3. The image display apparatus according to claim 1, wherein:
the controller tilts the 3D content screen or the object in the 3D content screen or changes the position of the OSD such that the OSD does not overlap the object in the 3D content screen, and
the display displays the tilted 3D content screen or the tilted object in the 3D content screen along with the OSD or displays the 3D content screen including the OSD, the position or shape of which is changed.

4. The image display apparatus according to claim 1, further comprising a lens unit arranged in front of the display, configured to separate multi-view images according to directions,
wherein the controller arranges the multi-view images corresponding to the 3D content screen.

5. The image display apparatus according to claim 1, wherein the controller senses a user gesture based on the image captured by the camera and operates based on the sensed user gesture.

6. A method for operating an image display apparatus, the method comprising:
displaying a three-dimensional (3D) content screen;
changing at least one of a depth of a predetermined object in the 3D content screen or an on screen display (OSD) if the OSD is included in the 3D content screen; and
displaying a 3D content screen including the object or OSD with the changed depth.

7. The method according to claim 6, wherein the changing the depth is performed if the depth of the predetermined object in the 3D content screen and the depth of the OSD are differently set.

8. The method according to claim 6, further comprising:
changing at least one of a position or shape of the OSD; and
displaying a 3D content screen including the OSD, the position or shape of which is changed.

9. The method according to claim 6, wherein, in the changing of the depth, the depth of the object in the 3D content screen is not changed and the depth of the OSD is changed such that the depth of the OSD is greater than the depth of the object in the 3D content screen.

10. The method according to claim 6, wherein, in the changing of the depth, the depth of the object in the 3D content screen is reduced to scale and the depth of the OSD is changed such that the depth of the OSD is greater than the reduced depth of the object in the 3D content screen.

11. The method according to claim 6, wherein, in the changing of the depth, the depth of the object in the 3D content screen is reduced by a predetermined depth and the depth of the OSD is changed such that the depth of the OSD is greater than the reduced depth of the object in the 3D content screen.

12. The method according to claim 8, wherein:
the changing the position or shape includes tilting the 3D content screen or the object in the 3D content screen, and
the displaying the 3D content screen including the OSD, the position or shape of which is changed, includes displaying the tilted 3D content screen or the tilted object in the 3D content screen along with the OSD.

13. The method according to claim 8, wherein the changing the position or shape includes changing the position of the OSD such that the OSD does not overlap the object in the 3D content screen.

14. The method according to claim 8, wherein the changing the position or shape includes changing the depth of the OSD to be equal to the depth of the object in the 3D content screen.

15. The method according to claim 8, wherein the changing the position or shape is performed if the depth of the object in the 3D content and the depth of the OSD are set to be equal.

16. The method according to claim 6, wherein the displaying the 3D content screen includes:
sensing a position of a user;
arranging multi-view images corresponding to the 3D content screen based on the position of the user;
separating the multi-view images according to directions.

17. The method according to claim 16, wherein the displaying the 3D content screen includes changing arrangement of the multi-view images according to change in position of the user.

18. The method according to claim 6, further comprising:
displaying a channel control or volume control object based on a user gesture;
sensing the user gesture; and
performing channel control or volume control based on the sensed user gesture.

19. The method according to claim 6, further comprising:
sensing a user gesture;
displaying a recent execution screen list according to the user gesture; and
displaying a selected recent execution screen if any one recent execution screen is selected from among the recent execution screen list.

20. A method for operating an image display apparatus, the method comprising:
displaying a 3D content screen;
changing at least one of a depth of a predetermined object in the 3D content screen or an on screen display (OSD) if the OSD is included in the 3D content screen and the depth of the predetermined object in the 3D content screen is set to be different from the depth of the OSD;
changing at least one of a position or shape of the OSD if the OSD is included in the 3D content screen and the depth of the predetermined object in the 3D content screen is set to be equal to the depth of the OSD; and
displaying a 3D content screen including the object or OSD with the changed depth or a 3D content screen including the OSD, the position or shape of which is changed.
